(19) United States
(12) Patent Application Publication
(10) Pub. No.: US 2014/0226196 A1
(43) Pub. Date: Aug. 14, 2014

(54) Optical Elements, Light Source Devices, and Projection Type Display Devices

(71) Applicants: Masanao Natsumeda, Tokyo (JP); Masao Imai, Tokyo (JP); Shin Tominaga, Tokyo (JP)

(72) Inventors: Masanao Natsumeda, Tokyo (JP); Masao Imai, Tokyo (JP); Shin Tominaga, Tokyo (JP)

(73) Assignee: NEC CORPORATION, Tokyo (JP)

(21) Appl. No.: 14/346,774

(22) PCT Filed: Jul. 18, 2012
(86) PCT No.: PCT/JP2012/068196

§ 371 Date: Mar. 24, 2014

(30) Foreign Application Priority Data
Sep. 27, 2011 (JP) 2011-211614
Jan. 6, 2012 (JP) 2012-001324

(51) Int. Cl. G02B 5/00

(52) U.S. Cl. CPC G02B 5/008
USPC 359/241

(57) ABSTRACT

According to the present invention, the etendue of light that exits an optical element can be decreased regardless of the etendue of light that exits a light emitting element.

An optical element according to the present invention includes a carrier generation layer that generates carriers with light; a plasmon excitation layer that is located on the carrier generation layer and that has a plasma frequency greater than the frequency of light that occurs in the carrier generation layer when it is excited with light that exits the light emitting element; an exit layer that is located on the plasmon excitation layer and that converts surface plasmons generated in the plasmon excitation layer into light having a predetermined exit angle; and at least one anisotropic dielectric layer that has anisotropy on an incident side in a direction from the plasmon excitation layer to the carrier generation layer.

### TECHNICAL FIELD

The present invention relates to optical elements, light source devices, and projection type display devices that use surface plasmons so as to emit light.

### BACKGROUND ART

An LED projector that uses a light emitting diode (LED) as a light emitting element for a light source device has been proposed. A LED projector of this type has a light source device having an LED; an illumination optical system into which light that exits the light source device enters; a light bulb having a liquid crystal display panel into which light that exits the illumination optical system enters; and a projection optical system that projects light that exits the light bulb to a projection surface.

LED projectors have been required that light loss in which occurs in an optical path from the light source device to the light bulb be as low as possible so as to improve the luminance of projection images.

In addition, as described in Non-Patent Literature 1, an LED projector is restricted by the etendue that depends on the product of the area and emission angle of the light source device. In other words, light that exits the light source device cannot be used as projection light unless the product of the light emission area and radiation angle of the light source is equal to or less than the product of the area of the incident surface of the light bulb and the acceptance angle (solid angle) that depends on the F number of the optical system.

Thus, in a light source device having an LED and an optical element into which light that exits the LED enters, there has been a problem in decreasing the etendue of light that exits the optical element of the light source device so as to decrease the foregoing light loss.

A light source device for an LED projector needs to use a plurality of LEDs that realize a projection light beam on the order of several thousand lumens that a single LED cannot emit.

As shown in FIG. 1, Patent Literature 1 discloses as an example of such a light source device that uses a plurality of LEDs a light source unit that is provided with a plurality of monochromatic light source devices 203a to 203f respectively having LEDs 204a to 204f; optical axis alignment members 202a to 202d that align optical axes of light that exits monochromatic light source devices 203a to 203f; light source sets 201a and 201b into which light that exits optical axis alignment members 202a to 202d enters; and light conducting device 200 into which light that exits light source sets 201a and 201b enters. In the light source unit, light that exits the plurality of monochromatic light source devices 203a to 203f is combined. The radiation angle of the resultant light is narrowed by light source sets 201a and 201b. The resultant light enters light conducting device 200. In this structure, the radiation angle of the light that enters light conducting device 200 is narrowed by light source sets 201a and 201b so as to decrease the light loss.

As shown in FIG. 2, Patent Literature 2 discloses, as another example, a light source device that uses a plurality of LEDs. The light source device is provided with light source substrate 301 on which a plurality of LEDs 300 are located. The light source device is provided with an optical element composed of two prism sheets 304 and 305 on which elongated prism members formed on prism sheet 304 are located orthogonal to those formed on prism sheet 305; and frame 303 that supports prism sheets 304 and 305. In this light source device, light that exits the plurality of LEDs 300 is combined by two prism sheets 304 and 305.

### RELATED ART LITERATURE

### Patent Literature

Patent Literature 1: JP2008-145510A, Publication
Patent Literature 2: JP2009-87695, Publication

### Non-Patent Literature

Non-Patent Literature 1: PhlatLight™ Photonic Lattice LEDs for RPTV Light Engines, Christine Hoepfner, SID Symposium Digest 37, 1808 (2006)

### SUMMARY OF THE INVENTION

### Problem to be Solved by the Invention

However, in the structure described in the foregoing Patent Literature 1, the light emission area of the dichroic reflection surfaces of optical axis alignment members 202a to 202d becomes greater than the light emission areas of LEDs 204a to 204f. Thus, the etendue of light that enters light conducting device 200 does not change from that of light that exits LEDs 204a to 204f. As a result, in the structure described in Patent Literature 1, the etendue of light that exits light conducting device 200 depends on that of light that exits LEDs 204a to 204f. Consequently, the etendue of light that exits light conducting device 200 can not be decreased.

On the other hand, in the structure described in Patent Literature 2, since the plurality of LEDs 300 are located on a surface, the light emission area of the entire light source becomes large. Thus, the etendue of light that exits the light source will increase.

In other words, in the structures disclosed in Patent Literatures 1 and 2, the etendue of light that exits the light source unit and the light source device depends on that of light that exits the LEDs. Thus, the etendue of light that exits the optical element can not be decreased.

An object of the present invention is to solve the problems of the related art technologies and provide optical devices that themselves can decrease the etendue of light that exits and also provide light source devices and projection type display devices provided with these optical elements.

### Means that Solve the Problem

To realize the foregoing object, an optical element according to the present invention includes a carrier generation layer that generates carriers with light; a plasmon excitation layer that is located on the carrier generation layer and that has a plasma frequency greater than the frequency of light that occurs in the carrier generation layer when it is excited with light that exits the light emitting element; an exit layer that is located on the plasmon excitation layer and that converts surface plasmons generated in the plasmon excitation layer into light having a predetermined exit angle; and at least one anisotropic dielectric layer that has anisotropy on an incident side in a direction from the plasmon excitation layer to the carrier generation layer.

In addition, a light source device according to the present invention includes an optical element according to the present invention; a light conductor; and a light emitting element located on an outer circumferential portion of the light conductor.

In addition, a projection type display device includes a light source device according to the present invention; a display element that modulates light that exits the light source device; and a projection optical system that projects a projection image with light that exits the display element.

In addition, an optical element includes a carrier generation layer that generates carriers with light; a plasmon excitation layer that is located on the carrier generation layer and has a plasma frequency that is greater than the frequency of light that occurs in the carrier generation layer when it is excited with light that exits the light emitting element; and at least one anisotropic dielectric layer that has optical isotropy and that is located on an incident side in a direction from the plasmon excitation layer to the carrier generation layer.

According to the present invention, the etendue of light that exits an optical element can be decreased regardless of the etendue of light that exits a light emitting element.

### BRIEF DESCRIPTION OF DRAWINGS

FIG. 1 is a schematic diagram describing the structure of Patent Literature 1.

FIG. 2 is an exploded perspective view showing the structure of Patent Literature 2.

FIG. 3 is a perspective view schematically showing a light source device according to the present invention.

FIG. 4 is a sectional view describing how light acts in a light source device according to the present invention.

FIG. 5A is a perspective view schematically showing a directivity control layer of the light source device according to a first embodiment of the present invention.

FIG. 5B is a perspective view schematically showing a directivity control layer of a light source device according to a second embodiment of the present invention.

FIG. 5C is a schematic diagram showing a luminous intensity distribution of radiation light depending on whether or not an anisotropic dielectric layer is present.

FIG. 5D is a schematic diagram showing a plasmon coupling efficiency when anisotropic dielectric layer 22 shown in FIG. 5A is present.

FIG. 6A is a sectional view describing a manufacturing step for the light source device according to the first embodiment of the present invention.

FIG. 6B is a sectional view describing a manufacturing step for the light source device according to the first embodiment of the present invention.

FIG. 6C is a sectional view describing a manufacturing step for the light source device according to the first embodiment of the present invention.

FIG. 6D is a sectional view describing a manufacturing step for the light source device according to the first embodiment of the present invention.

FIG. 6E is a sectional view describing a manufacturing step for the light source device according to the first embodiment of the present invention.

FIG. 6F is a sectional view describing a manufacturing step for the light source device according to the first embodiment of the present invention.

FIG. 6G is a sectional view describing a manufacturing step for the light source device according to the first embodiment of the present invention.

FIG. 7A is a sectional view describing a manufacturing step for the light source device according to a second embodiment of the present invention.

FIG. 7B is a sectional view describing a manufacturing step for the light source device according to the second embodiment of the present invention.

FIG. 7C is a sectional view describing a manufacturing step for the light source device according to the second embodiment of the present invention.

FIG. 7D is a sectional view describing a manufacturing step for the light source device according to the second embodiment of the present invention.

FIG. 7E is a sectional view describing a manufacturing step for the light source device according to the second embodiment of the present invention.

FIG. 8A is a sectional view describing a forming step for a photonic crystal of the light source device according to the second embodiment of the present invention.

FIG. 8B is a sectional view describing a forming step for the photonic crystal of the light source device according to the second embodiment of the present invention.

FIG. 8C is a sectional view describing a forming step for the photonic crystal of the light source device according to the second embodiment of the present invention.

FIG. 8D is a sectional view describing a forming step for the photonic crystal of the light source device according to the second embodiment of the present invention.

FIG. 9A is a sectional view describing a forming step for the photonic crystal of the light source device according to the second embodiment of the present invention.

FIG. 9B is a sectional view describing a forming step for the photonic crystal of the light source device according to the second embodiment of the present invention.

FIG. 9C is a sectional view describing a forming step for the photonic crystal of the light source device according to the second embodiment of the present invention.

FIG. 9D is a sectional view describing a forming step for the photonic crystal of the light source device according to the second embodiment of the present invention.

FIG. 9E is a sectional view describing a forming step for the photonic crystal of the light source device according to the second embodiment of the present invention.

FIG. 9F is a sectional view describing a forming step for the photonic crystal of the light source device according to the second embodiment of the present invention.

FIG. 9G is a sectional view describing a forming step for the photonic crystal of the light source device according to the second embodiment of the present invention.

FIG. 9H is a sectional view describing a forming step for the photonic crystal of the light source device according to the second embodiment of the present invention.

FIG. 10 is a perspective view schematically showing a light source device according to a third embodiment of the present invention.

FIG. 11A is a sectional view describing a forming step for a micro-lens array of a light source device according to the third embodiment of the present invention.

FIG. 11B is a sectional view describing a forming step of the micro-lens array of the light source device according to the third embodiment of the present invention.

FIG. 12 is a perspective view schematically showing a directivity control layer of a light source device according to a fourth embodiment of the present invention.

FIG. 13 is a perspective view schematically showing a directivity control layer of a light source device according to a fifth embodiment of the present invention.

FIG. 14 is a perspective view schematically showing a directivity control layer of a light source device according to a sixth embodiment of the present invention.

FIG. 15 is a perspective view schematically showing a directivity control layer of a light source device according to a seventh embodiment of the present invention.

FIG. 16 is a perspective view schematically showing a directivity control layer of a light source device according to an eighth embodiment of the present invention.

FIG. 17 is a perspective view schematically showing a directivity control layer of a light source device according to a ninth embodiment of the present invention.

FIG. 18 is a perspective view schematically showing a directivity control layer of a light source device according to a tenth embodiment of the present invention.

FIG. 19 is a perspective view schematically showing a structure in which a micro-lens array is located on a front surface of a directivity control layer according to an eleventh embodiment of the present invention.

FIG. 20A is a sectional view describing a forming step for the micro-lens array of the light source device according to the eleventh embodiment of the present invention.

FIG. 20B is a sectional view describing a forming step for the micro-lens array of the light source device according to the eleventh embodiment of the present invention.

FIG. 21 is a perspective view schematically showing a directivity control layer of a light source device according to a twelfth embodiment of the present invention.

FIG. 22 is a perspective view schematically showing a directivity control layer of a light source device according to a thirteenth embodiment of the present invention.

FIG. 23 is a perspective view schematically showing a directivity control layer of a light source device according to a fourteenth embodiment of the present invention.

FIG. 24 is a perspective view schematically showing a directivity control layer of a light source device according to a fifteenth embodiment of the present invention.

FIG. 25 is a perspective view schematically showing a directivity control layer of a light source device according to a sixteenth embodiment of the present invention.

FIG. 26 is a perspective view schematically showing a directivity control layer of a light source device according to a seventeenth embodiment of the present invention.

FIG. 27 is a perspective view schematically showing a directivity control layer of a light source device according to an eighteenth embodiment of the present invention.

FIG. 28 is a schematic diagram showing an LED projector to which a light source device according to an embodiment of the present invention is applied.

FIG. 29 is a schematic diagram describing the relationship of the wavelengths of a light source and the excitation wavelengths and emission wavelengths of phosphors used for an LED projector to which a light source device according to an embodiment of the present invention is applied.

FIG. 30 is a sectional view showing a structure in which a dielectric layer is located between a plasmon excitation layer and an anisotropic dielectric layer.

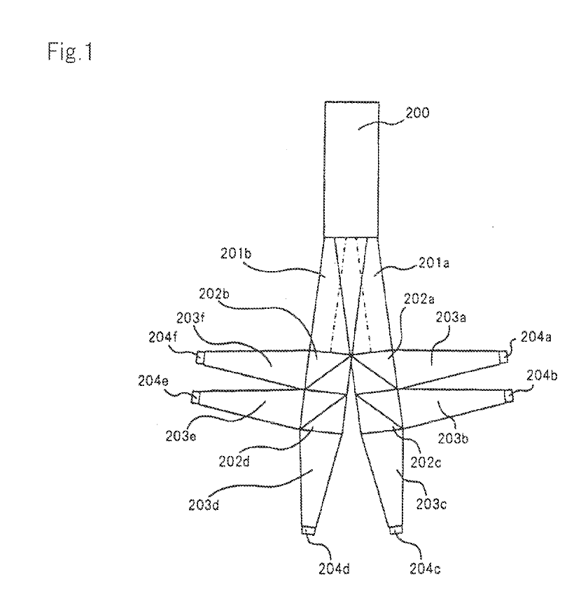

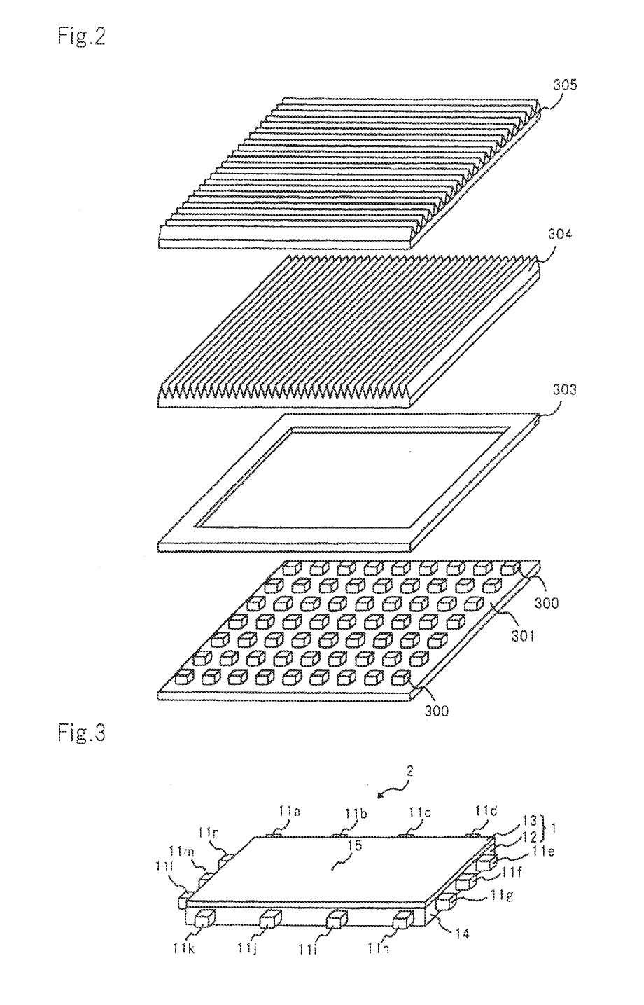

### BEST MODES THAT CARRY OUT THE INVENTION

Next, with reference to the accompanying drawings, embodiments of the present invention will be described.

### First Embodiment

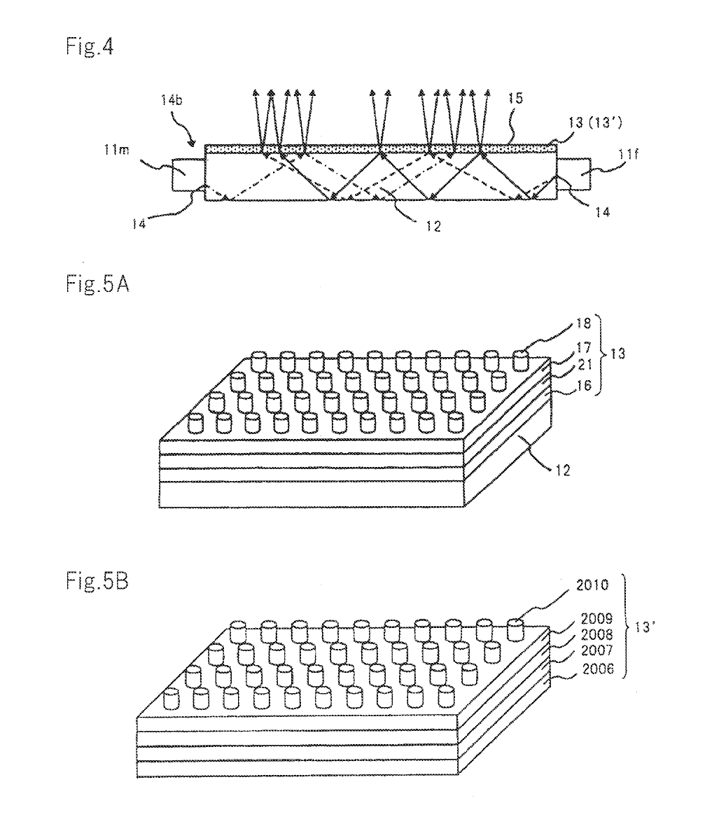

FIG. 3 is a perspective view schematically showing the structure of a light source device according to the present invention. FIG. 4 is a sectional view describing how light acts in the light source device according to the present invention. Since the individual layers of real light source devices are very thin and their thickness largely differs from each other, it is difficult to illustrate the individual layers in the exact scales. Thus, the drawings do not illustrate the individual layers in the exact scales, but schematically illustrate them.

As shown in FIG. 3 and FIG. 4, light source device 2 according to this embodiment is provided with a plurality of light emitting elements 11 (1 la to 11n) and optical element 1 into which light that exits light emitting elements 11 enters. Optical element 1 has light conductor 12 into which light that exits light emitting elements 11 enters; and directivity control layer 13 that emits light that exits light conductor 12.

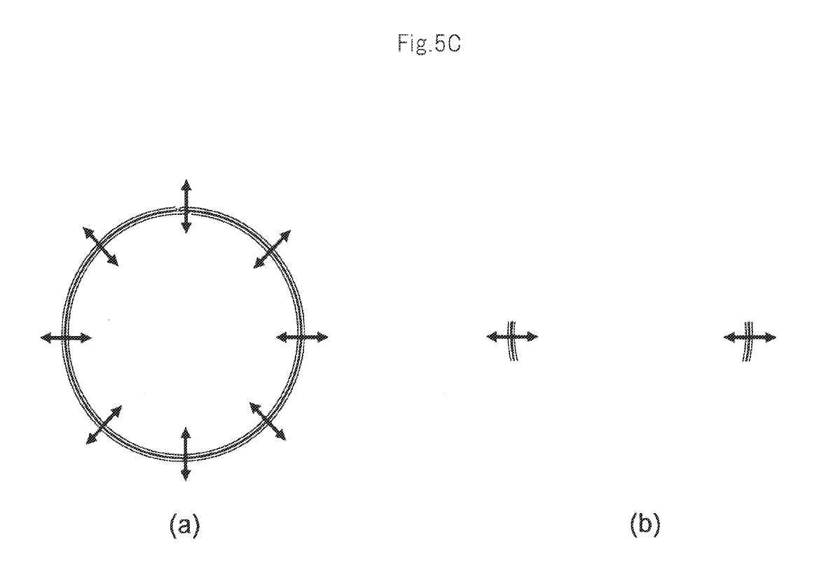

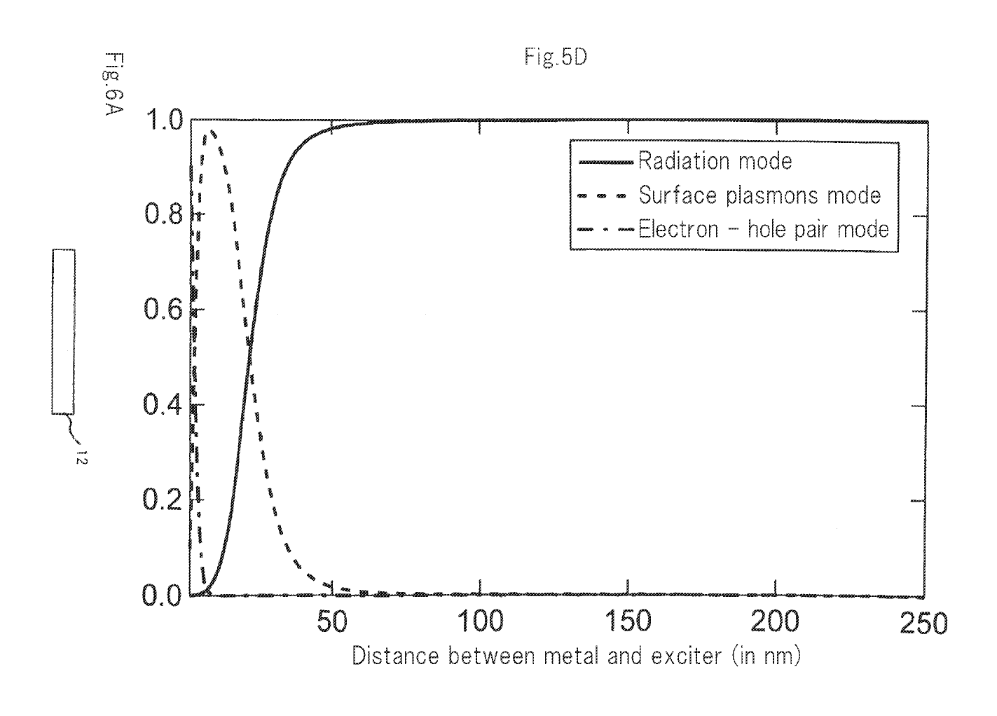

Directivity control layer 13 is a layer that improves the directivity of light that exits light source device 2. According to the first embodiment, as shown in FIG. 5A, directivity control layer 13 is provided with carrier generation layer 16 that is located on light conductor 12 and that generates carriers with part of light that exits light conductor 12; anisotropic high dielectric layer 22 located on carrier generation layer 16; plasmon excitation layer 17 having a plasma frequency greater than the frequency of light that occurs in carrier generation layer 16 when it is excited with light that exits light emitting elements 11; and wave number vector conversion layer 18 as an exit layer that is laminated on plasmon excitation layer 17 and that converts a wave number vector of surface plasmons that are generated in plasmon excitation layer 17 into light having a predetermined exit angle.

If carrier generation layer 16 can practically and sufficiently absorb light that exits light emitting elements 11, as long as light that exits light emitting elements 11 does not damage directivity control layer 13 or as long as the uniformity of light intensity on the light emission surface of light emitting elements 11 is not a problem, light conductor 12 according to this embodiment may be omitted.

Anisotropic high dielectric layer 22 according to this embodiment has optical isotropy that denotes that anisotropic high dielectric layer 22 has dielectric constants that vary on a surface perpendicular to the laminating direction of the structural members of directivity control layer 13, namely in directions on a surface in parallel with the interface of each layer. In other words, anisotropic high dielectric layer 22 has dielectric constants that vary in directions perpendicular to each other on a surface perpendicular to the laminating direction of the structural members of directivity control layer 13. In this context, a direction in which dielectric constants are large is defined as the on-surface high dielectric constant direction, whereas a direction in which dielectric constants are small is defined as the on-surface low dielectric constant direction.

Carrier generation layer 16 according to this embodiment is located immediately below plasmon excitation layer 17. Alternatively, a dielectric layer that has a thickness that is smaller than effective interaction distance d_{eff} of surface plasmons represented by formula 4 (that will be described later) may be located between carrier generation layer 16 and plasmon excitation layer 17.

Wave number vector conversion layer 18 according to this embodiment is located immediately above plasmon excitation layer 17. Alternatively, a dielectric layer that has a thickness that is less than effective interaction distance d_{eff} of surface plasmons expressed by formula 4 (that will be described later) may be located between wave number vector conversion layer 18 and plasmon excitation layer 17.

Plasmon excitation layer 17 is also located between two layers having dielectricity. According to this embodiment, these two layers correspond to carrier generation layer 16 and wave number vector conversion layer 18. Optical element 1 according to this embodiment has a structure where the effective dielectric constant of an incident side portion including the entire structure laminated on light conductor 12 side of plasmon excitation layer 17 and an ambient medium that is in contact with light conductor 12 (hereinafter, this medium is simply referred to as medium) (hereinafter, this incident side portion is simply referred to as incident side portion) is greater than that of an exit side portion including the entire structure laminated on wave number vector conversion layer 18 side of plasmon excitation layer 17 and a medium that is in contact with wave number vector conversion layer 18 (hereinafter, this exit side portion is simply referred to as exit side portion).

The entire structure laminated on light conductor 12 side of plasmon excitation layer 17 includes anisotropic high dielectric layer 22, carrier generation layer 16, and light conductor 12. The entire structure laminated on wave number vector conversion layer 18 side of plasmon excitation layer 17 includes wave number vector conversion layer 18.

In other words, according to the first embodiment, the effective dielectric constant of the incident side portion including light conductor 12, carrier generation layer 16, anisotropic high dielectric layer 22, and the medium with respect to plasmon excitation layer 17 is greater than that of the exit side portion including wave number vector conversion layer 18 and the medium with respect to plasmon excitation layer 17.

Specifically, the real part of the complex effective dielectric constant of the incident side portion (light emitting elements 11 side) of plasmon excitation layer 17 is set to be greater than that of the exit side portion (wave number vector conversion layer 18 side) of plasmon excitation layer 17.

It is assumed that directions that are in parallel with an interface of plasmon excitation layer 17 are represented by x and y axes; a direction perpendicular to the interface of plasmon excitation layer 17 (if plasmon excitation layer 17 is not flat, a direction perpendicular to the average surface) is represented by z axis; an angular frequency of light that exits carrier generation layer 16 is represented by w; a distribution of dielectric constants of a dielectric substance at the incident side portion and exit side portion with respect to plasmon excitation layer 17 is represented by ∈(ω, x, y, z); a z component of a wave number of surface plasmons is represented by k_{spp, z}; and an imaginary unit is represented by j.

Then, complex effective dielectric constant ∈_{eff} can be expressed based on the distribution of dielectric constants of the incident side portion or exit side portion and based on the distribution of surface plasmons in a direction perpendicular to the interface of plasmon excitation layer 17.

$$\begin{matrix}[ Mathematical Expression 1 ] & \\ {ɛ}_{eff} = {( \frac{\int {\int }_{D}^{ } \int Re [ \sqrt{ɛ ( ω , x , y , z )} ] exp ( 2 j {k}_{spp , z} z )}{\int {\int }_{D}^{ } \int exp ( 2 j {k}_{spp , z} z )} )}^{2} & Formula ( 1 )\end{matrix}$$

Integration range D is a range of the incident side portion or exit side portion in the three dimensional coordinates with respect to plasmon excitation layer 17. In other words, the ranges in the directions of the x axis and y axis in integration range D are ranges that do not include a medium on the outer circumferential surface of the structure that the incident side portion or exit side portion includes, but ranges that include the outer edge of a surface that is parallel with a surface on wave number vector conversion layer 18 side of plasmon excitation layer 17. On the other hand, the range in the direction of the z axis in integration range D is the range of the incident side portion or exit side portion (including the medium). It is assumed that the interface between plasmon excitation layer 17 and a layer that has dielectricity and that is located adjacent to plasmon excitation layer 17 is at the position where z=0, that the range in the direction of the z axis in integration range D is a range from the interface to infinity on the foregoing adjacent layer side of plasmon excitation layer 17, and that the direction that is apart from the interface is referred to as (+) z direction in Formula (1). If the front surface of plasmon excitation layer 17 is not flat, the effective dielectric constant can be obtained from Formula (1) in such a manner that the origin of the z axis is moved along plasmon excitation layer 17. If there is a material having optical anisotropy in the calculation range of the effective dielectric constant, ∈ (ω, x, y, z) becomes a vector that has values that vary in radial directions perpendicular to the z axis. In other words, the effective dielectric constants of the incident side portion and exit side portion vary in each radial direction perpendicular to the z axis. At this point, the value of ∈ (ω, x, y, z) is a dielectric constant of the incident side portion or exit side portion in the direction that is parallel with the radial direction perpendicular to the z axis. Thus, values with respect to the effective dielectric constant such as K_{spp, z}, Kₛₚₚ, and d_{eff} that will be described later vary in the radial direction perpendicular to the z axis.

Effective dielectric constant ∈_{eff} may be calculated from the formula that follows. However, it is preferred that effective dielectric constant ∈_{eff} be calculated from Formula (1).

$$\begin{matrix}[ Mathematical Expression 2 ] & \\ {ɛ}_{eff} = {( \frac{\int {\int }_{D}^{ } \int Re [ \sqrt{ɛ ( ω , x , y , z )} ] exp ( 2 j {k}_{spp , z} z )}{\int {\int }_{D}^{ } \int exp ( 2 j {k}_{spp , z} z )} )}^{2} & Formula ( 1.1 )\end{matrix}$$

Assuming that the real part of the dielectric constant of plasmon excitation layer 17 is expressed by ∈ₘₑₜₐₗ and that the wave number of light in vacuum is expressed by k₀,

$$\begin{matrix}[ Mathematical Expression 3 ] & \\ {k}_{spp , z} = \sqrt{{ɛ}_{eff} {k}_{0}^{2} - {k}_{spp}^{2}} & Formula ( 2 ) \\ [ Mathematical Expression 4 ] & \\ {k}_{spp} = {k}_{0} Re [ \sqrt{\frac{{ɛ}_{eff} {ɛ}_{metal}}{{ɛ}_{eff} + {ɛ}_{metal}}} ] & Formula ( 3 )\end{matrix}$$

z component k_{spp, z} and x and y components kₛₚₚ of the wave number of surface plasmons are expressed by the preceding Formulas (2) and (3), respectively.

where Re[ ] denotes that the real part of [ ] is obtained.

Thus, by inserting distribution of dielectric constants ∈ᵢₙ (ω, x, y, z) of the incident side portion of plasmon excitation layer 17 and distribution of dielectric constants ∈ₒᵤₜ (ω, x, y, z) of the exit side portion of plasmon excitation layer 17 as ∈ (ω, x, y, z) into Formula (1), Formula (2), and Formula (3), complex effective dielectric constant layer ∈_{effin} of the incident side portion with respect to plasmon excitation layer 17 and complex effective dielectric constant ∈_{effout} of the exit side portion with respect to plasmon excitation layer 17 are obtained. In practice, by giving an appropriate initial value as complex effective dielectric constant ∈_{eff} and iteratively calculating Formula (1), Formula (2) and Formula (3), complex effective dielectric constant ∈_{eff} can be easily obtained. If the real part of the dielectric constant of the layer that is in contact with plasmon excitation layer 17 is very large, z component k_{spp, z} of the wave number of the surface plasmons on the interface becomes a real number. This means that no surface plasmons occur on the interface. Thus, the dielectric constant of the layer that is in contact with plasmon excitation layer 17 corresponds to the effective dielectric constant in this case. Likewise, effective dielectric constants of the other embodiments are defined as Formula (1).

Assuming that the effective interaction distance of surface plasmons is a distance for which the intensity of surface plasmons becomes e⁻²,

$$\begin{matrix}[ Mathematical Expression 5 ] & \\ {d}_{eff} = Im [ \frac{1}{{k}_{spp , z}} ] & Formula ( 4 )\end{matrix}$$

effective interaction distance d_{eff} of surface plasmons can be expressed by Formula (4).

Anisotropic dielectric layer 22 allows the incident side portion to have effective dielectric constants that vary in directions perpendicular to each other on a surface perpendicular to the laminating direction of the structural members of directivity control layer 13. At this point, if the effective dielectric constants of the incident side portion are set to be as high as possible, then plasmon coupling will not occur in one direction, and if the effective dielectric constants of the incident side portion are set to as low as possible, plasmon coupling will occur in another direction perpendicular thereto, and thus light source device 2 will emits radiation light having a particular polarization component only in a particular direction.

FIG. 5C shows a luminous intensity distribution of radiation light depending on whether or not the anisotropic high dielectric layer is present.

FIG. 5C(a) shows a luminous intensity distribution of radiation light in a structure where anisotropic high dielectric layer 22 is removed from the embodiment shown in FIG. 5A, whereas FIG. 5C(b) shows a luminous intensity distribution of radiation light in the embodiment shown in FIG. 5A.

As shown in FIG. 5C(a), if anisotropic high dielectric layer 22 is removed from the embodiment shown in FIG. 5A, since plasmon coupling occurs in various directions, polarized radiation light is emitted in various directions. Since radiation light is emitted in various directions, it is difficult to effectively extract radiation light having directivity from wave number vector conversion layer 18 to the outside of light source device 2. In addition, since a projector uses only a particular polarization component for illumination light, only small part of radiation light extracted to the outside of light source device 2 is used as illumination light.

By contrast, in the embodiment shown in FIG. 5C(b), since light source device 2 emits radiation light having a particular polarization component in a particular direction, the projector can use the entire radiation light extracted to the outside of light source device 2 as illumination light.

FIG. 5D shows plasmon coupling efficiency in the structure where anisotropic high dielectric layer 22 is located. It is assumed that plasmon excitation layer 17 is made of Ag; the dielectric constant of Ag is −6.57+0.7366j; the light emission wavelength of emission light of carrier generation layer 16 is 460 nm; the quantum yield of the carrier generation layer is 100%; the effective dielectric constant in the on-surface high dielectric constant direction on anisotropic high dielectric layer 22 side is 6.76; and the effective dielectric constant in the on-surface low dielectric constant direction is 6.25.

If the distance between a metal and an exciter is adequate, the efficiency with which carriers generated in carrier generation layer 16 are coupled with surface plasmons becomes nearly 1.0 and thereby most of energy is converted into surface plasmons. On the other hand, carriers generated in carrier generation layer 16 are coupled with surface plasmons only if the sum of the effective dielectric constant on anisotropic high dielectric layer 22 side and the dielectric constant of plasmon excitation layer 17 is equal to 0. In this context, if the sum of the dielectric constant of plasmon excitation layer 17 and the effective dielectric constant on anisotropic high dielectric layer 22 side is −0.32, the efficiency in which carriers are coupled with surface plasmons becomes nearly 1.0. If the sum is 0.19, the efficiency with which carriers are coupled with surface plasmons becomes 0. Theoretically, if the sum of the dielectric constant of plasmon excitation layer 17 and the effective dielectric constant on anisotropic high dielectric layer 22 side is negative or 0, carriers generated in carrier generation layer 16 excite surface plasmons in plasmon excitation layer 17. If the sum is positive, surface plasmons are not excited. In other words, if the sum of the dielectric constant of plasmon excitation layer 17 and the effective dielectric constant on anisotropic high dielectric layer 22 side is positive, the effective dielectric constant will become as high as possible and thus plasmon coupling will not occur. If the sum of the dielectric constant of plasmon excitation layer 17 and the effective dielectric constant on anisotropic high dielectric layer 22 side is negative or 0, the effective dielectric constant will become as low as possible and plasmon coupling will thus occur. Thus, it is most preferred that the sum of the dielectric constant of plasmon excitation layer 17 and the minimum value of the effective dielectric constant on anisotropic high dielectric layer 22 side be 0 because directivity with respect to an azimuth is improved. However, in the foregoing condition, since the directivity with respect to the azimuth is excessively corrected, light that is transmitted through plasmon excitation layer 17 may be decreased and thereby plasmon excitation layer 17 may be heated. Thus, in practice, it is preferred that the directivity, with respect to the azimuth, be only moderately improved. Specifically, if the sum of the dielectric constant of plasmon excitation layer 17 and the median of the effective dielectric constant on anisotropic high dielectric layer 22 side is 0, since radiation light having high directivity occurs in azimuth ranges from 315 deg to 45 deg and from 135 deg to 225 deg, the directivity with respect to the azimuth can be improved and decrease of emission light can be reduced.

According to this embodiment, anisotropic high dielectric layer 22 is located as an anisotropic dielectric layer. Alternatively, at least one layer on the incident side of plasmon excitation layer 17 may have optical anisotropy such that the effective dielectric constants in the on-surface high dielectric constant direction on the anisotropic dielectric layer side are as high as possible and thus carriers will not be coupled with surface plasmons and if the effective dielectric constants in the on-surface low dielectric constant direction are as low as possible, then carriers will be coupled with surface plasmons. Specific examples of the material of anisotropic high dielectric layer 22 include TiO₂, YVO₄, and Ta₂O₅ that are anisotropic crystals; obliquely evaporated films of dielectric substances; and obliquely spattered films of dielectric substances. Energy converted into surface plasmons is extracted as light from wave number vector conversion layer 18 to the outside of light source device 2. At this point, energy of surface plasmons is distributed as the luminous intensity distribution shown in FIG. 5C(b). In contrast, if anisotropic high dielectric layer 22 is removed from this embodiment, energy of surface plasmons is distributed as the luminous intensity distribution shown in FIG. 5C(a). In other words, according to this embodiment, energy of surface plasmons is distributed to light that is used for illumination light of the projector. By contrast, if anisotropic high dielectric layer 22 is removed from this embodiment, energy of surface plasmons is also distributed to light that is not used for illumination light of the projector. Thus, the energy efficiency of this embodiment is greater than that of the structure where anisotropic high dielectric layer 22 is removed from this embodiment.

According to this embodiment, at the frequency of light that occurs in carrier generation layer 16 when it is excited with light that exits light emitting elements 11, it is preferred that the imaginary part of the complex dielectric constant of any layer including light conductor 12 and the medium that contacts wave number vector conversion layer 18 be as low as possible. When the imaginary part of the complex dielectric constant is set to be as low as possible, plasmon coupling tends to easily occur and decrease light loss.

The ambient medium of light source device 2, namely the medium that is in contact with light conductor 12 and wave number vector conversion layer 18, may be either solid, liquid, or gaseous. In addition, the ambient medium on light conductor 12 side may be different from that on wave number vector conversion layer 18 side.

According to this embodiment, the plurality of light emitting elements 11a to 11n are located at predetermined intervals on four side surfaces of planar light conductor 12. In this context, surfaces where light emitting elements 11a to 11n that is in contact with the side surfaces of light conductor 12 are referred to as light incident surfaces 14. Examples of light emitting elements 11 include light emitting diodes (LEDs), laser diodes, super-luminescence diodes, or the like that emit light having wavelengths that carrier generation layers 16 and 2006 can absorb. Light emitting elements 11 may be located apart from light incident surfaces 14 of light conductor 12. For example, light emitting elements 11 may be optically connected to light conductor 12 by a light conducting member.

According to this embodiment, light conductor 12 is formed in a planar shape that is a rectangular parallelepiped shape. However, it should be noted that the shape of light conductor 12 is not limited to the rectangular parallelepiped shape. Alternatively, light conductor 12 may contain a structural member such as a micro-prism that controls a luminous intensity characteristic. Further alternatively, a reflection film may be formed entirely or partly on an outer circumferential surface of light conductor 12 excluding light exit portion 15 and light incident surfaces 14. Likewise, a reflection film (not shown) may be formed entirely or partly on an outer circumferential surface of light source device 2 excluding light exit portion 15 and light incident surfaces 14. The reflection film may be made of, for example, a metal such as silver or aluminum or a dielectric laminate film.

Carrier generation layer 16 is made of an organic phosphor such as rhodamine 6G or sulforhodamine 101; a quantum dot phosphor such as CdSe or CdSe/ZnS quantum dots; an inorganic material such as GaN or GaAs (semiconductor); or an organic material such as (thiophene/phenylene) co-oligomer or Alq3 (semiconductor material). When carrier generation layer 16 is made of a phosphor, a plurality of fluorescent material having the same light emission frequency or different light emission frequencies may be contained in carrier generation layer 16. It is preferred that the thickness of carrier generation layer 16 be 1 μm or less.

Plasmon excitation layer 17 is a fine particle layer or a thin film layer made of a material having a plasma frequency greater than the frequency of light (light emission frequency) that occurs in carrier generation layer 16 when it is excited with light that exits light emitting elements 11. In other words, the real part of dielectric constant of plasmon excitation layer 17 is negative at the light emission frequency of light that occurs in carrier generation layer 16 when it is excited with light that exits light emitting elements 11.

Examples of the material of plasmon excitation layer 17 include gold, silver, copper, platinum, palladium, rhodium, osmium, ruthenium, iridium, iron, tin, zinc, cobalt, nickel, chromium, titanium, tantalum, tungsten, indium, aluminum, and alloys thereof. Among them, it is preferred that the material of plasmon excitation layer 15 be gold, silver, copper, platinum, aluminum, or an alloy that contains one of these metals as a primary component. It is particularly preferred that the material of plasmon excitation layer 15 be gold, silver, aluminum, or an alloy containing one of these metals as a primary component. It is preferred that plasmon excitation layer 17 be formed with a thickness of 200 nm or less. It is particularly preferred that plasmon excitation layer 17 be formed with a thickness in the range from around 10 nm to 100 nm. Wave number vector conversion layer 18 is an exit layer that converts surface plasmons excited on the interface between plasmon excitation layer 17 and wave number vector conversion layer 18 into a wave number vector, extracts light from the interface between plasmon excitation layer 17 and wave number vector conversion layer 18, and emits the resultant light.

Examples of wave number vector conversion layer 18 include a surface relief grating, a periodic structure typified by a photonic crystal, a quasi-periodic structure, a quasi-crystalline structure, a texture structure having a wavelength greater than that of light that exits optical element 1, a surface structure having a rough surface, a structure using a hologram, a micro-lens array, or the like. The quasi-periodic structure represents an imperfect periodic structure in which a periodic structure is partly lost. Among them, it is preferred that wave number vector conversion layer 18 be a periodic structure typified by a photonic crystal, a quasi-periodic structure, a semi-crystalline structure, or a structure having a micro-lens array. They not only can improve light extraction efficiency, but can also control the directivity. When wave number vector conversion layer 18 is made of a photonic crystal, it is preferred that the photonic crystal have a triangular grating crystalline structure. Wave number vector conversion layer 18 may be formed in such a manner that a convex pattern or a concave pattern is formed on a planar substrate. According to the following embodiments, wave number vector conversion layer 18 is a structure made of only a photonic crystal. Alternatively, wave number vector conversion layer 18 may be any one of the foregoing structures.

Next, how light that has exited light emitting elements 11 and then entered directivity control layer 13 exits light exit portion 15 of directivity control layer 13 will be described.

As shown in FIG. 4, light that exits light emitting element 11f of the plurality of light emitting elements 11 is transmitted through light incident surfaces 14 of light conductor 12 and propagates through light conductor 12 while the light is totally reflected on the inner surfaces of light conductor 12. At this point, directivity control layer 13, using Formula (5), that follows, converts light that enters the interface between light conductor 12 and directivity control layer 13 into light that has a direction and a wavelength. Thereafter, the resultant light exits light exit portion 15. Light that has not entered directivity control layer 13 from among light that has exited light emitting element 11f returns to light conductor 12. Thereafter, part of light that enters the interface between light conductor 12 and directivity control layer 13 is converted into light having a direction and a wavelength corresponding to the characteristics of directivity control layer 13. Thereafter, the resultant light exits light exit portion 15. Through these iterations, most of light that enters light conductor 12 exits light exit portion 15. Likewise, light that has exited light emitting element 11m located opposite to light emitting element 11f with light conductor 12 of the plurality of light emitting elements 11 and that has been transmitted through light incident surfaces 14 is converted into light having a direction and a wavelength by directivity control layer 13 in the foregoing manner. The resultant light exits light exit portion 15. The direction and wavelength of light that exits light exit portion 15 depend only on the characteristics of directivity control layer 13, not on the position of light emitting elements 11 and the incident angle to the interface between light conductor 12 and directivity control layer 13. Hereinafter, unless otherwise specified, the structure having wave number vector conversion layer 18 made of a photonic crystal will be described.

Next, the characteristics of directivity control layer 13 will be described. Carriers are generated in carrier generation layer 16 with light that exits light emitting elements 11 and that propagates through light conductor 12. The generated carriers are coupled with free electrons in plasmon excitation layer 17 as plasmon coupling. As a result, surface plasmons are excited on the interface between plasmon excitation layer 17 and wave number vector conversion layer 18 through plasmon coupling. Wave number vector conversion layer 18 diffracts the excited surface plasmons. The resultant surface plasmons exit light source device 2.

If the dielectric constants on the interface between plasmon excitation layer 17 and wave number vector conversion layer 18 are spatially uniform, namely if the interface is planar, surface plasmons that occur on the interface cannot be extracted. Thus, according to the present invention, wave number vector conversion layer 18 diffracts surface plasmons such that they are extracted as light. Light that exits one point of wave number vector conversion layer 18 has a ring-shaped intensity distribution where light concentrically spreads as it propagates. If the center exit angle in Formula (5) that follows becomes 0, there is a single peak intensity distribution where a light intensity peak appears in the direction of the z axis.

Assuming that an exit angle at which light has the highest intensity is the center exit angle, that the pitch of the periodic structure of wave number vector conversion layer 18 is represented by A, and that the refractive index on the light extraction side of the wave number vector conversion layer (namely, the medium that is in contact with the wave number vector conversion layer) is represented by n_{rad}, center exit angle θ_{rad} of light that exits wave number vector conversion layer 17 can be expressed by the following formulas.

$$\begin{matrix}[ Mathematical Expression 6 ] & \\ {θ}_{rad} = {sin}^{- 1} ( \frac{{k}_{spp} - i \frac{2 π}{Λ}}{{n}_{rad} {k}_{0}} ) & Formula ( 5 )\end{matrix}$$

where i is a positive or negative integer. Since only surface plasmons in the neighborhood of the wave number expressed by Formula (3) are present on the interface between plasmon excitation layer 17 and wave number vector conversion layer 18, the angular distribution of exit light expressed by Formula (5) also becomes narrow.

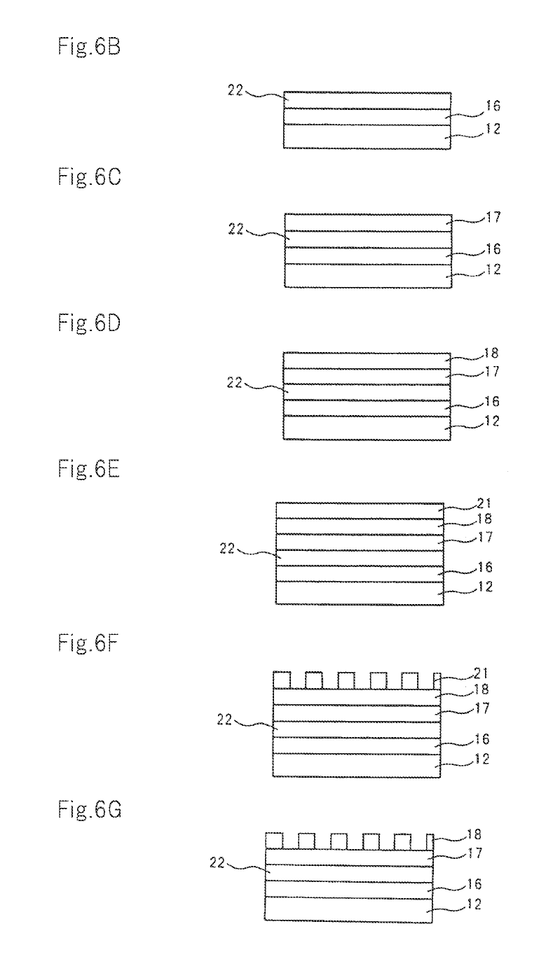

FIG. 6A to FIG. 6G show manufacturing steps for optical element 1 of light source device 2. The manufacturing steps shown in FIG. 6A to FIG. 6G are just examples. Thus, it should be noted that the present invention is not limited to the manufacturing steps shown in FIG. 6A to FIG. 6G. First, as shown in FIGS. 6A and 6B, carrier generation layer 16 is formed on light conductor 12 according to the spin coat technique. Thereafter, as shown in FIG. 6C, anisotropic high dielectric layer 22 and plasmon excitation layer 17 are formed on carrier generation layer 16 according to, for example, the physical evaporation technique, electron beam evaporation technique, or spattering technique.

Thereafter, as shown in FIG. 6D, wave number vector conversion layer 18 made of a photonic crystal is formed on carrier generation layer 16. Thereafter, as shown in FIG. 6E, resist film 21 is coated on wave number vector conversion layer 18 according to the spin coat technique. Thereafter, as shown in FIG. 6F, a negative pattern made of a photonic crystal is transferred to resist film 21 according to the nano-imprint technique. Thereafter, as shown in FIG. 6G, wave number vector conversion layer 18 is etched out for a desired depth according to the dry etch technique. Thereafter, resist film 21 is peeled off from wave number vector conversion layer 18. Last, the plurality of light emitting elements 11 are located on the outer circumferential portions of light conductor 12. As a result, light source device 2 is completed.

As described above, because light source device 2 according to this embodiment has a relatively simple structure where directivity control layer 13 is located on light conductor 12, the entire structure of light source device 2 can be miniaturized. Moreover, in light source device 2 according to this embodiment, the incident angle of light that enters wave number vector conversion layer 18 depends on the complex dielectric constant of plasmon excitation layer 17, the effective dielectric constant of the incident side portion with respect to plasmon excitation layer 17, the effective dielectric constant of the exit side portion with respect to plasmon excitation layer 17, and the light emission spectrum of light that occurs in light source device 2. Thus, the directivity of light that exits optical element 1 is not restricted by the directivity of light emitting elements 11. In addition, since light source device 2 according to each embodiment uses plasmon coupling emissions to radiate light, light source device 2 can narrow the radiation angle of light that exits optical element 1 so as to improve the directivity of the light that exits optical element 1. In other words, according to this embodiment, the etendue of light that exits light source device 2 can be decreased regardless of the etendue of light emitting elements 11. In addition, since the etendue of light that exits light source device 2 is not restricted by the etendue of light emitting elements 11, light that exits the plurality of light emitting elements 11 can be combined while the etendue of light that exits light source device 2 is kept low.

Moreover, in the structure disclosed in the foregoing Patent Literature 1, optical axis alignment members 202a to 202d and light source sets 201a and 210b cause the entire structure of the light source device to become large. By contrast, in optical element 1 according to this embodiment, the entire structure of optical element 1 can be miniaturized.

Moreover, in the structure disclosed in the foregoing Patent Literature 2, light that exits the plurality of LEDs 300 will be bent in various directions by prism sheets 304 and 305 that are located perpendicular to each other. As a result, light loss will occur. However, optical element 1 according to each embodiment can improve the use efficiency of light that exits the plurality of light emitting elements 11.

### Second Embodiment

FIG. 5B is a schematic diagram showing the structure of principal members of a second embodiment of the present invention. The structure of directivity control layer 13′ according to the second embodiment is different from that of directivity control layer 13 according to the first embodiment. Thus, FIG. 5B shows only directivity control layer 13′. Directivity control layer 13′ has carrier generation layer 2006 that is located on light conductor 12 and that generates carriers with part of light that exits light conductor 12; plasmon excitation layer 2008 that is laminated on carrier generation layer 2006 and that has a plasma frequency greater than the frequency of light that occurs in carrier generation layer 2006 when it is excited with light that exits light emitting elements 11; and wave number vector conversion layer 2010 as an exit layer that is laminated on plasmon excitation layer 2008 and that converts a wave number vector of the incident light and emits the resultant light.

Plasmon excitation layer 2008 is located between two layers each having dielectricity. As the two layers having dielectricity, directivity control layer 13′ according to this embodiment has high dielectric layer 2009 located between plasmon excitation layer 2008 and wave number vector conversion layer 2010; and anisotropic low dielectric layer 2007 that is located between carrier generation layer 2006 and plasmon excitation layer 2008 and that has a dielectric constant less than that of high dielectric layer 2009. As will be described later, if the effective dielectric constant of the incident side portion is less than that of the exit side portion, high dielectric layer 2009 is not an essential structural member in the operation of this embodiment.

Optical element 1 according to this embodiment has a structure where the effective dielectric constant of an incident side portion including the entire structure laminated on light conductor 12 side of plasmon excitation layer 2008 (hereinafter, this incident side portion is simply referred to as incident side portion) is less than that of an exit side portion including the entire structure laminated on wave number vector conversion layer 2010 side of plasmon excitation layer 2008 and a medium that contacts wave number vector conversion layer 10 (hereinafter, this exit side portion simply referred to as exit side portion). The entire structure laminated on light conductor 12 side of plasmon excitation layer 2008 includes light conductor 12. The entire structure laminated on wave number vector conversion layer 2010 side of plasmon excitation layer 2008 includes wave number vector conversion layer 2010.

In other words, according to this embodiment, the effective dielectric constant of the incident side portion including light conductor 12 and plasmon excitation layer 2008 with respect to plasmon excitation layer 2008 is smaller than that of the exit side portion including wave number vector conversion layer 2010 and the medium with respect to plasmon excitation layer 2008.

Specifically, the real part of the complex effective dielectric constant of the incident side portion (light emitting elements 11 side) of plasmon excitation layer 17 is set to be smaller than that of the exit side portion (wave number vector conversion layer 2010 side) of plasmon excitation layer 2008.

According to this embodiment, at the frequency of light that occurs in carrier generation layer 16 when it is excited with light that exits light emitting elements 11, it is preferred that the imaginary part of the complex dielectric constant of any layer including light conductor 12 and the medium that is in contact with wave number vector conversion layer 2010 be as low as possible. When the imaginary part of the complex dielectric constant is set to be as low as possible, plasmon coupling tends to easily occur and decrease light loss.

The ambient medium of light source device 50, namely the medium that is in contact with light conductor 12 and wave number vector conversion layer 2010, may be either solid, liquid, or gaseous. In addition, the ambient medium on light conductor 12 side may be different from that on wave number vector conversion layer 2010 side.

Anisotropic low dielectric layer 2007 according to the second embodiment has anisotropy like anisotropic high dielectric layer 21 according to the first embodiment. Anisotropic low dielectric layer 2007 causes radiation light due to plasmon coupling to be restricted in one polarization direction.

According to this embodiment, anisotropic low dielectric layer 2007 is located as an anisotropic dielectric layer. Alternatively, at least one layer on the incident side of plasmon excitation layer 2008 may have optical anisotropy such that the effective dielectric constants in the high dielectric constant direction on the anisotropic dielectric layer that are as high as possible and thus carriers will not be coupled with surface plasmons and the effective dielectric constants in the low dielectric constant direction on the anisotropic dielectric layer are as low as possible and thus carriers will be coupled with surface plasmons. Specific examples of anisotropic low dielectric layer 2007 include TiO₂, YVO₄, Ta₂O₅, and an obliquely evaporated film.

It is preferred that high dielectric layer 2009 be made of a material having a high dielectric constant such as diamond, TiO₂, CeO₂, Ta₂O₅, ZrO₂, Sb₂O₃, HfO₂, La₂O₃, NdO₃, Y₂O₃, ZnO, or Nb₂O₅.

Plasmon excitation layer 2008 is a fine particle layer or a thin film layer made of a material having a plasma frequency greater than the frequency of light (light emission frequency) that occurs in carrier generation layer 2006 when it is excited with light that exits light emitting elements 1. In other words, at the light emission frequency of light that occurs in carrier generation layer 2006 when it is excited with light that exits light emitting elements 1, plasmon excitation layer 2008 has a negative dielectric constant.

Wave number vector conversion layer 2010 is an exit layer that converts a wave number vector of light that enters wave number vector conversion layer 2010, extracts the resultant light, and causes the extracted light to exit optical element 1. In other words, wave number vector conversion layer 2010 converts surface plasmons into light having a predetermined exit angle and causes the resultant light to exit optical element 1. Thus, wave number vector conversion layer 2010 has a function that causes light to exit optical element 1 in a direction nearly perpendicular to the interface between plasmon excitation layer 2008 and wave number vector conversion layer 2010.

Instead of a photonic crystal, as wave number vector conversion layer 2010, a micro-lens array may be located on high dielectric layer 2009 on the opposite side of light conductor 12 or on a rough surface.

Next, how light that has exited light emitting elements 11 and entered directivity control layer 13′ exits light exit portion 15 of directivity control layer 13′ will be described.

With reference to FIG. 4, an operation of this embodiment will be described. As shown in FIG. 4, light that exits light emitting element 11f from among the plurality of light emitting elements 11 is transmitted through light incident surfaces 14 of light conductor 12 and propagates while the light totally reflects on the inner surfaces of light conductor 12. At this point, part of light that enters the interface between light conductor 12 and directivity control layer 13′ is converted into light having a direction and a wavelength by directivity control layer 13′ as expressed by Formula (6) that will be described later. Thereafter, the resultant light exits wave number vector conversion layer 2010. Light that has exited light emitting element 11f and that has not entered directivity control layer 13′ returns to light conductor 12. Thereafter, part of light that enters the interface between light conductor 12 and directivity control layer 13′ is converted into light having a direction and a wavelength corresponding to the characteristics of directivity control layer 13′ and then exits light exit portion 15. Through these iterations, most of light that has entered light conductor 12 exits light exit portion 15. Likewise, light that has exited light emitting element 11m located opposite to light emitting element 11f with light conductor 12 and that has been transmitted through light incident surfaces 14 is converted into light having a direction and a wavelength by directivity control layer 13 in the foregoing manner. The resultant light exits light exit portion 15. The direction and wavelength of light that exits light exit portion 15 depend only on the characteristics of directivity control layer 13′, not on the position of light emitting elements 11 and the incident angle of light that enters the interface between light conductor 12 and directivity control layer 13′. Unless otherwise specified, wave number vector conversion layer 2010 is made of a photonic crystal. Next, with reference to FIG. 5B, the structure having wave number vector conversion layer 2010 made of a photonic crystal will be described.

Next, the characteristics of directivity control layer 13′ will be described. Carrier generation layer 2006 generates carriers with light that exits light emitting elements 11 and that propagates through light conductor 12. The generated carriers are coupled with free electrons in plasmon excitation layer 2008 as plasmon coupling. As a result, light exits the interface between plasmon excitation layer 2008 and wave number vector conversion layer 2010 through plasmon coupling. Wave number vector conversion layer 2010 diffracts the light. The resultant light exits light source device 2.

If wave number vector conversion layer 2010 is not provided, since the light that exits the interface between light source device 2 and air at an exit angle exceeds the total reflection angle, the light cannot be extracted. Thus, according to the present invention, wave number vector conversion layer 2010 is provided so as to diffract the light and extract it.

Assuming that an exit angle at which the intensity of light is the highest is the center exit angle and that the refractive index of high dielectric layer 2009 is represented by nₒᵤₜ, center exit angle θₒᵤₜ of light that enters wave number vector conversion layer 2010 can be expressed by the following formulas.

$$\begin{matrix}[ Mathematical Expression 7 ] & \\ {θ}_{out} = {sin}^{- 1} ( \frac{{k}_{spp}}{{n}_{out} {k}_{0}} ) & Formula ( 6 )\end{matrix}$$

Since only surface plasmons in the neighborhood of the wave number expressed by Formula (3) occur on the interface between plasmon excitation layer 2008 and anisotropic low dielectric layer 2007, the angular distribution of exit light expressed by Formula (6) becomes narrow.

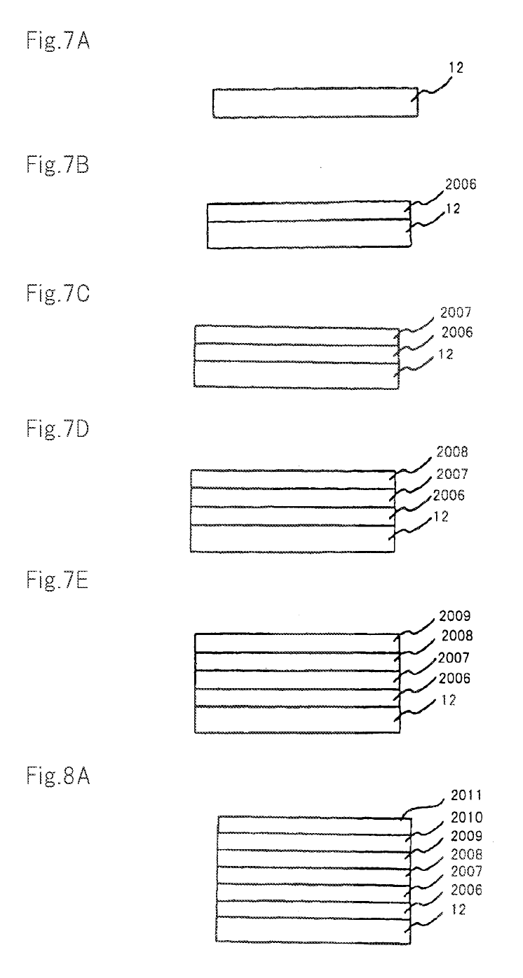

FIG. 7A to FIG. 7E show manufacturing steps for optical element 1 according to the second embodiment. The manufacturing steps shown in FIG. 7A to FIG. 7E are just examples. Thus, it should be noted that the present invention is not limited to the manufacturing steps shown in FIG. 7A to FIG. 7E. First, as shown in FIGS. 7A and 7B, carrier generation layer 2006 is coated on light conductor 12 according to the spin coat technique. Thereafter, as shown in FIG. 7C to FIG. 7E, anisotropic low dielectric layer 2007, plasmon excitation layer 2008, and high dielectric layer 2009 are successive laminated on carrier generation layer 2006 according to for example the physical evaporation technique, electron beam evaporation technique, or spattering technique.

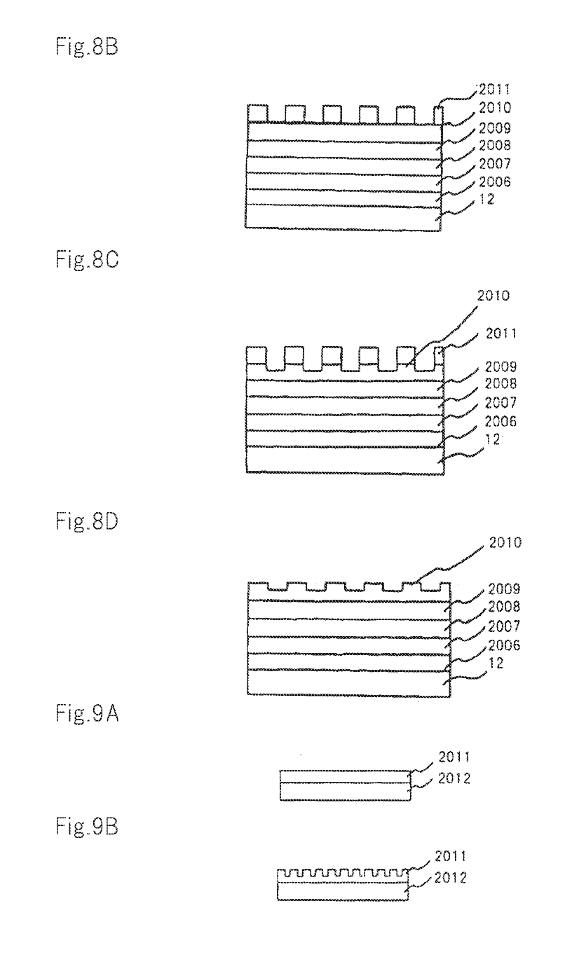

FIG. 8A to FIG. 8D show manufacturing steps for wave number vector conversion layer 10 made of a photonic crystal. As shown in FIG. 8A, wave number vector conversion layer 2010 is formed on high dielectric layer 2009. Thereafter, resist film 2011 is coated on wave number vector conversion layer 2010 according to the spin coat technique. Thereafter, as shown in FIG. 8B, a negative pattern made of a photonic crystal is transferred to resist film 2011 according to the nano-imprint technique. Thereafter, as shown in FIG. 8C, wave number vector conversion layer 2010 is etched out for a desired depth according to the dry etch technique. Thereafter, as shown in FIG. 8D, resist film 2011 is peeled off from wave number vector conversion layer 2010. Last, the plurality of light emitting elements 11 are located on the outer circumferential portion of light conductor 12. As a result, light source device 2 is completed.

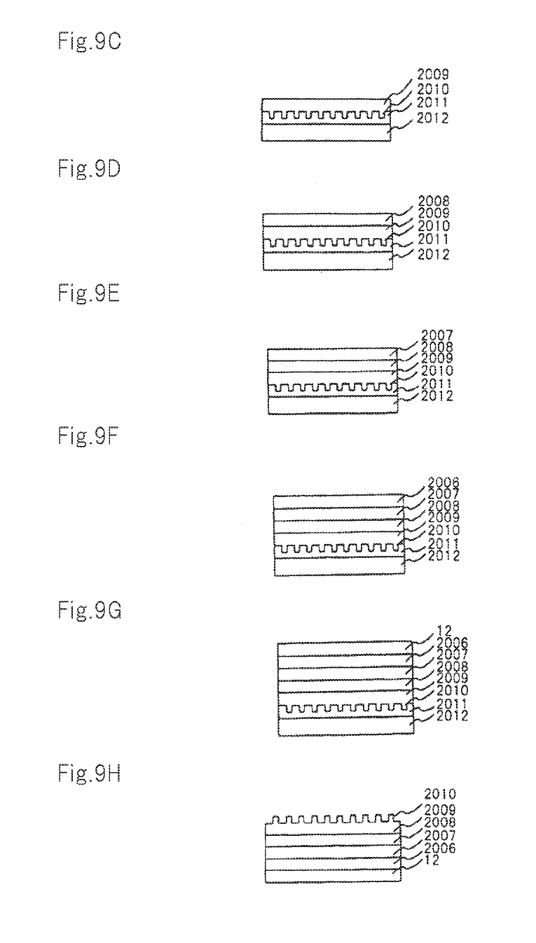

FIG. 9A to FIG. 9H show manufacturing steps for wave number vector conversion layer 2010 made of a photonic crystal formed on the front surface of high dielectric layer 2009 of light source device 2. The manufacturing steps shown in FIG. 9A to FIG. 9H are just examples. Thus, it should be noted that the present invention is not limited to the manufacturing steps shown in FIG. 9A to FIG. 9E.

First, as shown in FIG. 9A, resist film 2011 is coated on substrate 11 according to the spin coat technique. Thereafter, as shown in FIG. 9B, a negative pattern made of a photonic crystal is transferred to resist film 2011 according to the nano-imprint technique. Thereafter, as shown in FIG. 9C to FIG. 9E, high dielectric layer 2009, plasmon excitation layer 2008, and anisotropic low dielectric layer 2007 are successively laminated according to the physical evaporation technique, electron beam evaporation technique, or spattering technique. Thereafter, as shown in FIG. 9F, carrier generation layer 2006 is coated on low dielectric layer 2007 according to the spin coat technique. Thereafter, as shown in FIG. 9G, light conductor 12 is clamped to carrier generation layer 2006 and then dried. Last, as shown in FIG. 9H, resist film 2011 is peeled off from substrate 2012 and the plurality of light emitting elements 1 are located at the outer circumferential portions of light conductor 12. As a result, light source device 2 is completed.

As described above, since light source device 2 according to this embodiment has a relatively simple structure where directivity control layer 13′ is located on light conductor 12, the entire structure of light source device 2 can be miniaturized. In addition, in light source device 2 according to this embodiment, the incident angle of light that enters wave number vector conversion layer 18 depends on the complex dielectric constant of plasmon excitation layer 17, the effective dielectric constant of the incident side portion with respect to plasmon excitation layer 17, the effective dielectric constant of the exit side portion with respect to plasmon excitation layer 17, and the light emission spectrum of light that occurs in light source device 2. Thus, the directivity of light that exits optical element 1 is not restricted by the directivity of light emitting elements 11. In addition, since light source device 2 according to this embodiment uses plasmon coupling for radiation light, light source device 2 can narrow the radiation angle of light that exits optical element 1 so as to improve the directivity of exit light. In other words, according to this embodiment, the etendue of light that exits light source device 2 can be decreased regardless of the etendue of light emitting elements 11. In addition, since the etendue of light that exits light source device 2 is not restricted by the etendue of light that exits light emitting elements 11, light that exits the plurality of light emitting elements 11 can be combined while the etendue of light that exits light source device 2 is kept low.

Moreover, in the structure disclosed in the foregoing Patent Literature 1, optical axis alignment members 202a to 202d and light source sets 201a and 210b cause the entire structure of the light source device to become large. By contrast, in optical element 1 according to this embodiment, the entire structure of optical element 1 can be miniaturized.

Moreover, in the structure disclosed in the foregoing Patent Literature 2, light that exits the plurality of LEDs 300 will be bent in various directions by prism sheets 304 and 305 located perpendicular to each other and thereby light loss will occur. However, optical element 1 according to each embodiment can improve the use efficiency of light that exits the plurality of light emitting elements 11.

### Third Embodiment

Next, a light source device according to a third embodiment of the present invention will be described. The structure of the light source device according to the third embodiment is different from that of light source device 2 according to the first embodiment only as regards the structure of directivity control layer 13. Thus, only the structure of directivity control layer 13 will be described. In the directivity control layer according to each embodiment, similar portions to those in directivity control layer 13 according to the first embodiment are represented by similar reference numerals and their description will be omitted.

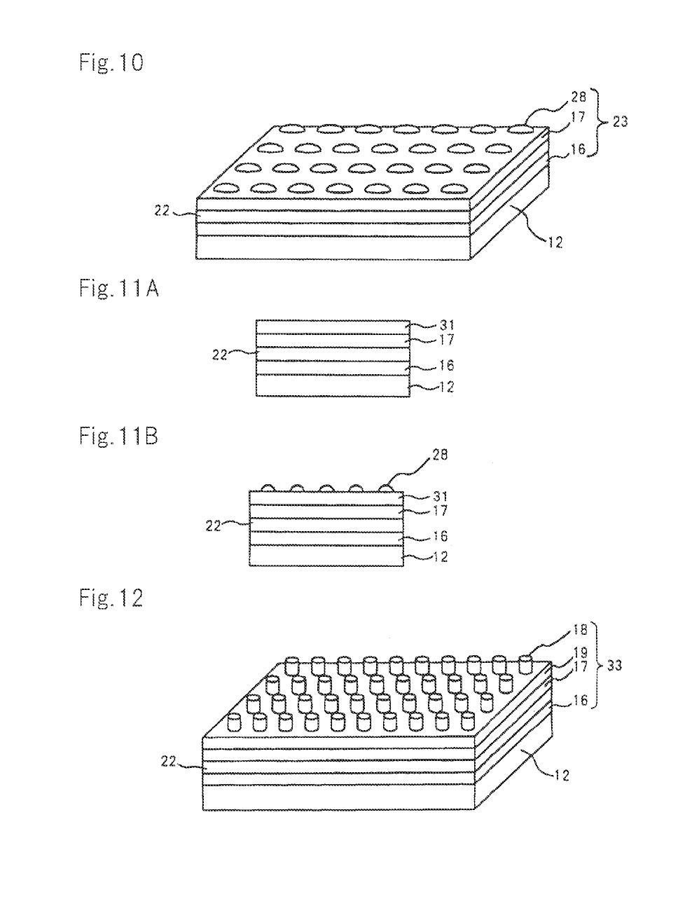

The structure of wave number vector conversion layer 28 according to the third embodiment is different from the structure of wave number vector conversion layer 18 according to the first embodiment shown in FIG. 5A. Wave number vector conversion layer 28 may be a micro-lens array layer or a rough surface layer instead of a photonic crystal layer. FIG. 10 is a perspective view schematically showing the directivity control layer of the light source device according to the third embodiment.

As shown in FIG. 10, directivity control layer 23 has wave number vector conversion layer 28 made of a micro-lens array located on the front surface of plasmon excitation layer 17. Even if directivity control layer 23 has wave number vector conversion layer 28 made of a micro-lens array, directivity control layer 23 has the same effect as the structure having wave number vector conversion layer 18 made of a photonic crystal.

FIG. 11A and FIG. 11B are sectional views describing manufacturing steps for the structure where a micro-lens array is laminated on plasmon excitation layer 17. In the structure of directivity control layer 23 where a micro-lens array is formed on plasmon excitation layer 17, since carrier generation layer 16, anisotropic high dielectric layer 22, and plasmon excitation layer 17 are successively laminated on light conductor 12 similar to the manufacturing steps shown in FIG. 6A to FIG. 6G, their description will be omitted.

As shown in FIG. 11A and FIG. 11B, after carrier generation layer 16, anisotropic high dielectric layer 22, and plasmon excitation layer 17 are laminated on light conductor 12 similar to the manufacturing steps shown in FIG. 6A to FIG. 6G, wave number vector conversion layer 28 composed of a micro-lens array is formed on the front surface of plasmon excitation layer 17. These manufacturing steps are just examples. Thus, it should be noted that the present invention is not limited to these manufacturing steps. As shown in FIG. 11A, after UV curable resin 31 is coated on the front surface of plasmon excitation layer 17 according to the spin coat technique or the like, a desired lens array pattern is formed on UV curable resin 31 according to the nano-imprint technique. Thereafter, UV curable resin 31 is irradiated with light such that UV curable resin 31 hardens. As a result, the micro-lens array is completed.

Although directivity control layer 23 according to the second embodiment has wave number vector conversion layer 28 composed of a micro-lens array, directivity control layer 23 has the same effect as the first embodiment.

The embodiments that follow have a structure where wave number vector conversion layer 18 is made of a photonic crystal. However, as described above, wave number vector conversion layer 18 may be substituted for wave number vector conversion layer 28 composed of a micro-lens array. Wave number vector conversion layer 28 composed of a micro-lens array has the same effect as each embodiment.

### Fourth Embodiment

FIG. 12 is a perspective view showing a directivity control layer of a light source device according to a fourth embodiment of the present invention. As shown in FIG. 12, in directivity control layer 33 according to the fourth embodiment, carrier generation layer 16, anisotropic high dielectric layer 22, plasmon excitation layer 17, dielectric layer 19, and wave number vector conversion layer 18 are successively laminated on light conductor 12.

Thus, the fourth embodiment is different from the first embodiment in that dielectric layer 19 is located as an independent layer between plasmon excitation layer 17 and wave number vector conversion layer 18. Since the dielectric constant of dielectric layer 19 is set to be less than that of dielectric layer 20 (high dielectric layer 20) according to a fifth embodiment of the present invention (that will be described later), hereinafter dielectric layer 19 is referred to as low dielectric layer 19. The dielectric constant of low dielectric layer 19 is set in the range in which the effective dielectric constant of the exit side portion with respect to plasmon excitation layer 17 is smaller than the effective dielectric constant of the incident side portion with respect to plasmon excitation layer 17. In other words, the dielectric constant of low dielectric layer 19 does not need to be smaller than that of the incident side portion with respect to plasmon excitation layer 17.

Low dielectric layer 19 may be made of a material different from that of wave number vector conversion layer 18. Thus, according to this embodiment, the degree of freedom of selecting the material of wave number vector conversion layer 18 can be increased.

It is preferred that low dielectric layer 19 be a thin film or a porous film made of, for example, SiO₂, AlF₃, MgF₂, Na₃AlF₆, NaF, LiF, CaF₂, BaF₂, or a low dielectric constant plastic. In addition, it is preferred that the thickness of low dielectric layer 19 be as low as possible. The allowable maximum value of the thickness of low dielectric layer 19 corresponds to the permeating length of surface plasmons that occur in the thickness direction of low dielectric layer 19 calculated according to Formula (4). If the thickness of low dielectric layer 19 exceeds the value calculated according to Formula (4), it becomes difficult to extract surface plasmons as light.

In directivity control layer 33 according to the fourth embodiment, the effective dielectric constant of the incident side portion including light conductor 12 and carrier generation layer 16 is set to be greater than the effective dielectric constant of the exit side portion including wave number vector conversion layer 18, low dielectric layer 19, and the medium that is in contact with wave number vector conversion layer 18 such that plasmon coupling occurs in plasmon excitation layer 17.

Directivity control layer 33 according to the fourth embodiment has the same effect as the first embodiment. In addition, since directivity control layer 33 has low dielectric layer 19 as an independently layer, the effective dielectric constant of the exit side portion of plasmon excitation layer 17 can be easily adjusted.

### Fifth Embodiment

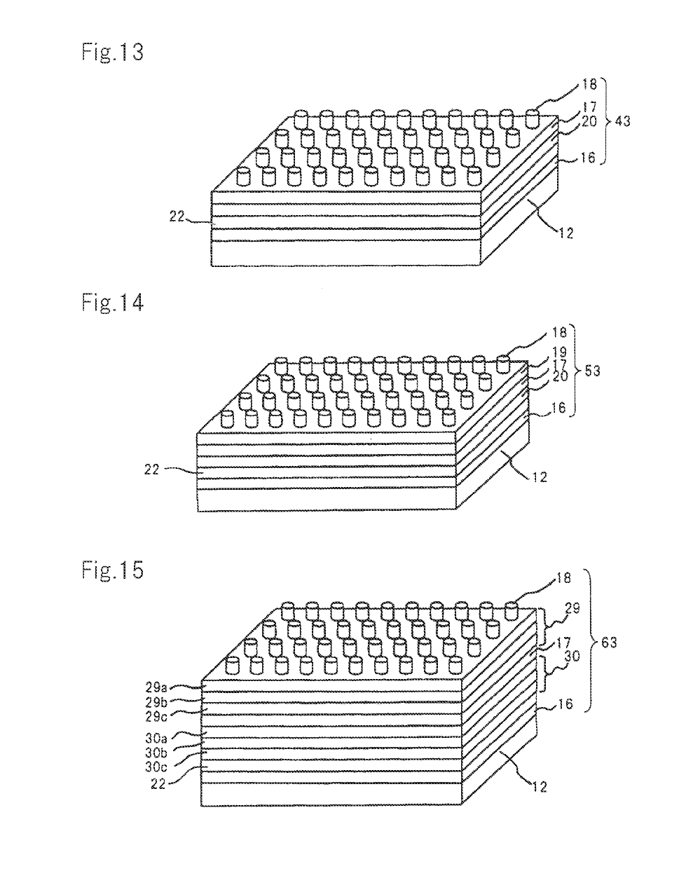

FIG. 13 is a perspective view showing a directivity control layer of a light source device according to a fifth embodiment of the present invention. As shown in FIG. 13, in directivity control layer 43 according to the fifth embodiment, carrier generation layer 16, anisotropic high dielectric layer 22, dielectric layer 20, plasmon excitation layer 17, and wave number vector conversion layer 18 made of a photonic crystal are successively laminated on light conductor 12.

Thus, the fifth embodiment is different from the first embodiment in that dielectric layer 20 is located as an independent layer between plasmon excitation layer 17 and carrier generation layer 16. Since the dielectric constant of dielectric layer 20 is set to be greater than that of low dielectric layer 19 according to the fourth embodiment, hereinafter dielectric layer 20 is referred to as high dielectric layer 20. The dielectric constant of high dielectric layer 20 is set in the range such that the effective dielectric constant of the exit side portion with respect to plasmon excitation layer 17 is less than the effective dielectric constant of the incident side portion with respect to plasmon excitation layer 17. In other words, the dielectric constant of high dielectric layer 20 does not need to be greater than the effective dielectric constant of the exit side portion with respect to plasmon excitation layer 17.

High dielectric layer 20 may be made of a material different from that of carrier generation layer 16. Thus, according to this embodiment, the degree of freedom of selecting the material of carrier generation layer 16 can be increased.

It is preferred that high dielectric layer 20 be a thin film or a porous film made of a material having a high dielectric constant such as diamond, TiO₂, CeO₂, Ta₂O₅, ZrO₂, Sb₂O₃, HfO₂, La₂O₃, NdO₃, Y₂O₃, ZnO, or Nb₂O₅. In addition, it is preferred that high dielectric layer 20 be made of a material having conductivity. Moreover, it is preferred that the thickness of high dielectric layer 20 be as low as possible. The allowable maximum value of the thickness of high dielectric layer 20 corresponds to the distance for which surface plasmons occur between carrier generation layer 16 and plasmon excitation layer 17 and can be calculated according to Formula (4).

In directivity control layer 43 according to the fifth embodiment, the effective dielectric constant of the incident side portion including light conductor 12, carrier generation layer 16, and high dielectric layer 20 is set to be greater than the effective dielectric constant of the exit side portion including wave number vector conversion layer 18 and the medium that is in contact with wave number vector conversion layer 18 such that plasmon coupling occurs in plasmon excitation layer 17.

Directivity control layer 43 according to the fifth embodiment has the same effect as the first embodiment. In addition, since directivity control layer 43 has high dielectric layer 20 as an independent layer, the effective dielectric constant of the incident side portion of plasmon excitation layer 17 can be easily adjusted. In addition, since the ratio according to which carriers generated in carrier generation layer 16 are lost as heat in plasmon excitation layer 17 is decreased, directivity control layer 43 can extract light having high directivity with higher efficiency than the first embodiment.

### Sixth Embodiment

FIG. 14 is a perspective view showing a directivity control layer of a light source device according to a sixth embodiment of the present invention. As shown in FIG. 14, directivity control layer 53 has low dielectric layer 19 located between plasmon excitation layer 17 and wave number vector conversion layer 18; and high dielectric layer 20 that is located between anisotropic high dielectric layer 22 and plasmon excitation layer 17 and that has a dielectric constant greater than that of low dielectric layer 19.

In directivity control layer 53 according to the sixth embodiment, the effective dielectric constant of the incident side portion including light conductor 12, carrier generation layer 16, and high dielectric layer 20 is set to be greater than the effective dielectric constant of the exit side portion including wave number vector conversion layer 18, low dielectric layer 19, and the medium that contacts wave number vector conversion layer 18.

Directivity control layer 53 according to the sixth embodiment has the same effect as the first embodiment. In addition, since directivity control layer 53 has low dielectric layer 19 and high dielectric layer 20 as independent layers, the effective dielectric constants of the exit side portion and the incident side portion of plasmon excitation layer 17 can be independently and easily adjusted. Moreover, directivity control layer 53 according to the sixth embodiment has the same effect as the first embodiment. In addition, since the ratio according to which carriers generated in carrier generation layer 16 are lost as heat in plasmon excitation layer 17 is decreased, directivity control layer 53 can extract light having higher directivity with higher efficiency than the first embodiment.

According to the sixth embodiment, low dielectric layer 19 is located on wave number vector conversion layer 18 side of plasmon excitation layer 17 and high dielectric layer 20 is located on carrier generation layer 16 side of plasmon excitation layer 17. However, it should be noted that the present invention is not limited to such a structure. Alternatively, as long as the effective dielectric constant of the incident side portion of plasmon excitation layer 17 is greater than that of the exit side portion of plasmon excitation layer 17, low dielectric layer 19 and high dielectric layer 20 that have any dielectric constants may be used. In other words, depending on dielectric constants of layers other than low dielectric layer 19 and high dielectric layer 20, the dielectric constant of low dielectric layer 19 may be less than that of high dielectric layer 20.

### Seventh Embodiment

FIG. 15 is a perspective view showing a directivity control layer of a light source device according to a seventh embodiment of the present invention. As shown in FIG. 15, the structure of directivity control layer 63 according to the seventh embodiment is the same as that of directivity control layer 53 according to the sixth embodiment except that each of low dielectric layer 19 and high dielectric layer 20 is composed of a plurality of dielectric layers that are successively laminated.

In other words, directivity control layer 63 according to the seventh embodiment has low dielectric layer group 29 in which a plurality of dielectric layers 29a to 29c are laminated; and high dielectric layer group 30 in which a plurality of dielectric layers 30a to 30c are laminated.

In low dielectric layer group 29, the plurality of dielectric layers 29a to 29c are located such that their dielectric constants simply decrease in the direction from plasmon excitation layer 17 to wave number vector conversion layer 18. Likewise, in high dielectric layer group 30, the plurality of dielectric layers 30a to 30c are located such that their dielectric constants simply increase in the direction from carrier generation layer 16 to plasmon excitation layer 17.

The total thickness of low dielectric layer group 29 is equal to the thickness of a low dielectric layer as an independent layer of a directivity control layer according to each embodiment. Likewise, the total thickness of high dielectric layer group 30 is equal to the thickness of a high dielectric layer as an independent layer of a directivity control layer according to each embodiment. According to the seventh embodiment, the number of layers of each of low dielectric layer group 29 and high dielectric layer group 30 is three. Alternatively, the number of layers of each of low dielectric layer group 29 and high dielectric layer group 30 may be two to five. If necessary, the number of layers of low dielectric layer group 29 or high dielectric layer group 30 may be different from the remaining low dielectric layer group 29 or high dielectric layer group 30. Alternatively, low dielectric layer group 29 or high dielectric layer group 30 may have a plurality of dielectric layers.

Since each high dielectric layer and each low dielectric layer is composed of a plurality of dielectric layers, the dielectric constants of the dielectric layers located adjacent to the interface of plasmon excitation layer 17 can be appropriately set. In addition, the refractive index of carrier generation layer 16, wave number vector conversion layer 18, or an ambient medium such as air that is in contact with wave number vector conversion layer 18 can be matched with the refractive index of each of the dielectric layers located adjacent thereto. In other words, high dielectric layer group 30 can decrease the difference of the refractive indices on the interface between plasmon excitation layer 17 and wave number vector conversion layer 18 or a medium such as air. Likewise, low dielectric layer group 29 can decrease the difference of the refractive indices on the interface between plasmon excitation layer 17 and carrier generation layer 16.

Directivity control layer 63 according to the sixth embodiment can adequately set the dielectric constant of each dielectric layer located adjacent to plasmon excitation layer 17 and decrease the difference of the refractive indices on the interface between plasmon excitation layer 17 and carrier generation layer 16 and on the interface between plasmon excitation layer 17 and wave number vector conversion layer 18. Thus, directivity control layer 63 can further decrease light loss and further improve the use efficiency of light that exits light emitting elements 11.

A single layer film in which dielectric constants simply vary may be used instead of low dielectric layer group 29 and high dielectric layer group 30. In this case, the high dielectric layer has a distribution of dielectric constants in which the dielectric constants gradually increase in the direction from carrier generation layer 16 to plasmon excitation layer 17. Likewise, the low dielectric layer has a distribution of dielectric constants in which the dielectric constants gradually decrease in the direction from plasmon excitation layer 17 to wave number vector conversion layer 18.

### Eighth Embodiment

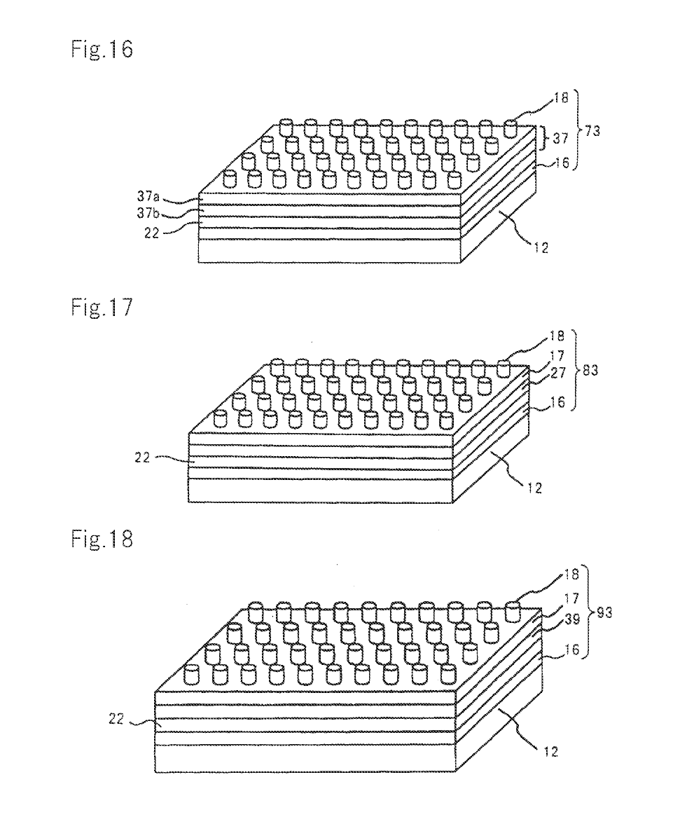

FIG. 16 is a perspective view showing a directivity control layer of a light source device according to an eighth embodiment of the present invention. As shown in FIG. 16, the structure of directivity control layer 73 according to the eighth embodiment is the same as the structure of directivity control layer 13 according to the first embodiment except that plasmon excitation layer group 37 is composed of a plurality of metal layers 37a and 37b that are laminated.

In plasmon excitation layer group 37 of directivity control layer 73 according to the eighth embodiment, metal layers 37a and 37b made of different metal materials are laminated. Thus, the plasma frequency of plasmon excitation layer group 37 can be adjusted.

If the plasma frequency of plasmon excitation layer group 37 needs to be increased, metal layers 37a and 37b are made of, for example, Ag and Al, respectively. In contrast, if the plasma frequency of plasmon excitation layer group 37 needs to decreased, metal layers 37a and 37b are made of, for example, Ag and Au, respectively.

Although plasmon excitation layer group 37 is composed of, for example, two layers, if necessary, it may be composed of three or more layers. It is preferred that the thickness of plasmon excitation layer group 37 be equal to or less than 200 nm. It is particularly preferred that the thickness of plasmon excitation layer group 37 be in the range from around 10 nm to 100 nm.

In directivity control layer 73 according to the eighth embodiment, since plasmon excitation layer group 37 is composed of a plurality of metal layers 37a and 37b, the effective plasma frequency of plasmon excitation layer group 37 can be adjusted to become close to the frequency of light that exits carrier generation layer 16 and enters plasmon excitation layer group 37. Thus, the use efficiency of light that exits light emitting elements 11 and enters optical element 1 can be further improved.

### Ninth Embodiment

FIG. 17 is a perspective view showing the directivity control layer of a light source device according to a ninth embodiment of the present invention. As shown in FIG. 17, directivity control layer 83 has plasmon excitation layer 27 as another plasmon excitation layer as well as plasmon excitation layer 17 according to the first embodiment.

In directivity control layer 83 according to the ninth embodiment, plasmon excitation layer 27 is located between carrier generation layer 16 and light conductor 12. In directivity control layer 83, plasmon excitation layer 27 excites plasmons with light that exits light conductor 12. The excited plasmons cause carrier generation layer 16 to generate carriers.

At this point, the dielectric constant of carrier generation layer 16 is set to be less than the dielectric constant of light conductor 12 such that plasmons resonate in plasmon excitation layer 27. In addition, a dielectric layer may be located between plasmon excitation layer 27 and carrier generation layer 16 such that the real part of the complex dielectric constant of the dielectric layer is less than that of light conductor 12 so as to increase the degree of freedom of selecting the material of carrier generation layer 16.

The plasma frequency of plasmon excitation layer 27 is greater than the light emission frequency of light that occurs in carrier generation layer 16 when it is excited with light that exits light emitting elements 11. In addition, the plasma frequency of plasmon excitation layer 27 is greater than the light emission frequency of light that exits light emission elements 11. If carrier generation layer 16 having a plurality of light emission frequencies that differ from each other is used, the plasma frequency of plasmon excitation layer 27 is greater than the frequencies of light that occurs in carrier generation layer 16 when it is excited with light that exits light emitting elements 11. Likewise, if a plurality of light emitting elements having different light emission frequencies are used, the plasma frequency of plasmon excitation layer 27 is greater than each of the light emission frequencies of the light emitting elements.

In such a structure, since carrier generation layer 16 generates carriers with plasmons, the fluorescence enhancing effect of plasmons can be used.

According to the ninth embodiment, since carrier generation layer 16 effectively generates carriers because of the fluorescence enhancing effect of plasmons and thereby the quantity of carriers is increased, the use efficiency of light that exit light emitting elements 11 can be further improved.

Like plasmon excitation layer group 37 according to the eighth embodiment, plasmon excitation layer 27 may be composed of a plurality of metal layers that are successively laminated.

### Tenth Embodiment

FIG. 18 is a perspective view showing a directivity control layer of a light source device according to a tenth embodiment of the present invention.

As shown in FIG. 18, the structure of directivity control layer 93 according to the tenth embodiment is the same as the structure of directivity control layer 13 according to the first embodiment except that low dielectric layer 39 that differs from low dielectric layer 19 in their operations is located between carrier generation layer 16 and light conductor 12.

In directivity control layer 93 according to the tenth embodiment, low dielectric layer 39 is located immediately below carrier generation layer 16. The dielectric constant of low dielectric layer 39 is set to be less than that of light conductor 12. The incident angle of light that enters light incident surfaces 14 of light conductor 12 is set to a predetermined angle such that light that exits light emitting elements 11 is totally reflected on the interface between light conductor 12 and low dielectric layer 39.

The light that exits light emitting elements 11 and enters light conductor 12 is totally reflected on the interface between light conductor 12 and low dielectric layer 39. Through the total reflection, evanescent waves occur. The evanescent waves cause carrier generation layer 16 to generate carriers.

In the light source device according to each of the foregoing first and third to ninth embodiments, part of light that exits light emitting elements 11 is transmitted through each layer and exits the light source device. Thus, two types of light having wavelengths that differ from each other for around 30 nm to 300 nm exits the light source device corresponding to the light emission wavelength of light emitting elements 11 and the light emission wavelength of carrier generation layer 16. However, according to the tenth embodiment, since evanescent waves cause carrier generation layer 16 to generate carriers, light having the light emission wavelength of light emitting elements 11 can be decreased and light having the light emission wavelength of carrier generation layer 16 can be increased. Thus, according to the ninth embodiment, the use efficiency of light that exits light emitting elements 11 can be further improved.

### Eleventh Embodiment

In directivity control layers according to embodiments that follow, layers similar to those in directivity control layer 13′ according to the second embodiment are represented by similar reference numerals and their description will be omitted.

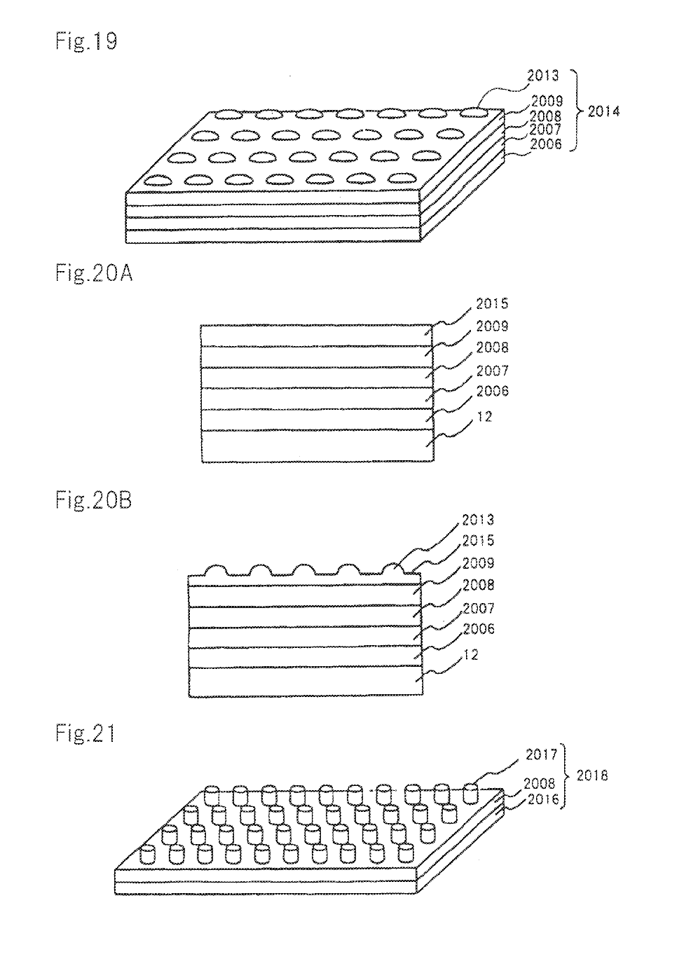

As shown in FIG. 19, the structure of directivity control layer 2014 according to the eleventh embodiment is the same as the structure of high dielectric layer 2009 according to the second embodiment except that dielectric layer 2014 has micro-lens array 2013. Even if dielectric layer 2014 has micro-lens array 2013, dielectric layer 2014 has the same effect as wave number vector conversion layer 2010 made of a photonic crystal.

FIG. 20A and FIG. 20B are sectional views describing manufacturing steps for the structure in which micro-lens array 2013 is laminated on high dielectric layer 2009. In the structure having micro-lens array 2013, since layers including carrier generation layer 2006 and high dielectric layer 2009 are laminated on light conductor 12 like the manufacturing steps shown in FIG. 7A to FIG. 7E, their description will be omitted.

As shown in FIG. 20A and FIG. 20B, after layers including carrier generation layer 2006 and high dielectric layer 2009 are laminated on light conductor 12 like the manufacturing steps shown in FIG. 7A to FIG. 7E, micro-lens array 2013 is formed on the front surface of high dielectric layer 2009. This structure is just an example. Thus, it should be noted that the present invention is not limited to such manufacturing steps. After UV curable resin 2015 is coated on the front surface of high dielectric layer 2009 according to the spin coat technique or the like, a desired lens array pattern is formed on UV curable resin 2015 according to the nano-imprint technique. Thereafter, UV curable resin 2015 is irradiated with light. As a result, micro-lens array 2013 is completed.

### Twelfth Embodiment

FIG. 21 is a perspective view showing a directivity control layer of a light source device according to a twelfth embodiment of the present invention. As shown in FIG. 21, in directivity control layer 2018 according to the sixth embodiment, carrier generation layer 2016, plasmon excitation layer 2008, and wave number vector conversion layer 2017 made of a photonic crystal are successively laminated on light conductor 12.

In directivity control layer 2018 according to the twelfth embodiment, wave number vector conversion layer 2017 also operates as high dielectric layer 2009 according to the second embodiment. In addition, carrier generation layer 2016 also operates as anisotropic low dielectric layer 2007 according to the second embodiment. Thus, the dielectric constant of wave number vector conversion layer 2017 located adjacent to the exit side interface of plasmon excitation layer 2008 is set to be greater than that of carrier generation layer 2016 that is located adjacent to the incident side interface of plasmon excitation layer 2008 such that plasmon coupling occurs in plasmon excitation layer 2008.

The light source device according to the twelfth embodiment has the same effect as the second embodiment. In addition, the light source device according to the twelfth embodiment can be further miniaturized in comparison with the second embodiment.

### Thirteenth Embodiment

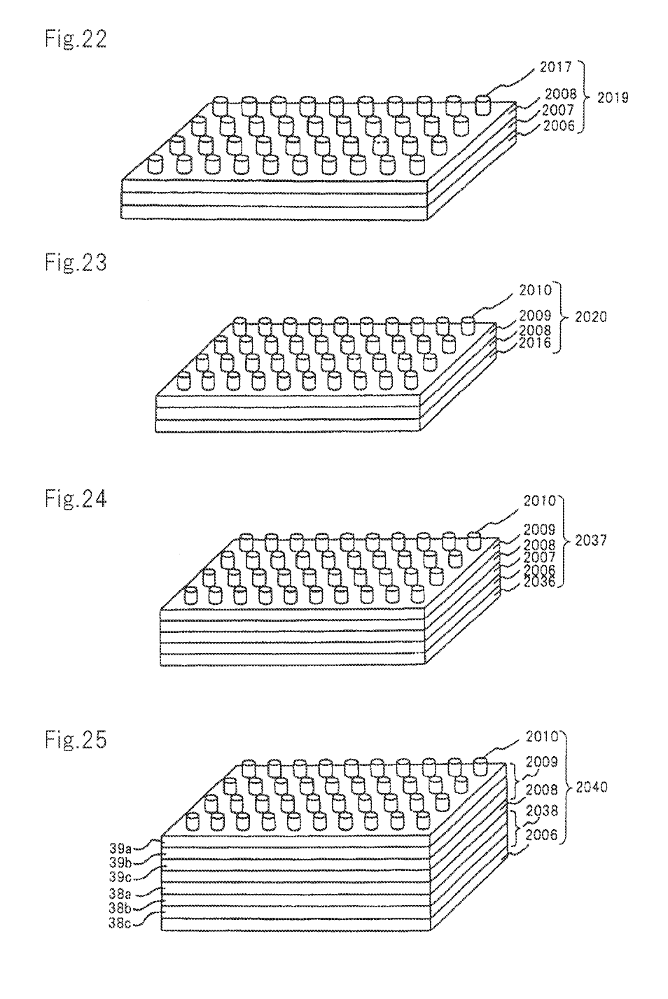

FIG. 22 is a perspective view showing a directivity control layer of a light source device according to a thirteenth embodiment of the present invention. As shown in FIG. 22, in directivity control layer 2019 according to the eighth embodiment, carrier generation layer 2006, anisotropic low dielectric layer 2007, plasmon excitation layer 2008, and wave number vector conversion layer 2017 made of a photonic crystal are successively laminated on light conductor 12.

In directivity control layer 2019 according to the thirteenth embodiment, wave number vector conversion layer 2017 also operates as high dielectric layer 2009 according to the second embodiment. Thus, the dielectric constant of wave number vector conversion layer 2017 is set to be greater than that of anisotropic low dielectric layer 2007 such that plasmon coupling occurs in plasmon excitation layer 2008. However, even if the dielectric constant of wave number vector conversion layer 2017 is smaller than the dielectric constant of anisotropic low dielectric layer 2007, as long as the real part of the effective dielectric constant on wave number vector conversion layer 2017 side of plasmon excitation layer 2008 is greater than that on anisotropic low dielectric layer 2007 side of plasmon excitation layer 2008, directivity control layer 2019 operates. In other words, the dielectric constant of wave number vector conversion layer 2017 is set in the range such that the real part of the effective dielectric constant of the exit side portion of plasmon excitation layer 2008 is greater than that of the incident side portion of plasmon excitation layer 2008.

The light source device according to the thirteenth embodiment has the same effect as the second embodiment. In addition, the light source device according to the thirteenth embodiment can be further miniaturized in comparison with the second embodiment.

### Fourteenth Embodiment

FIG. 23 is a perspective view showing the directivity control layer of a light source device according to a fourteenth embodiment of the present invention. As shown in FIG. 23, in directivity control layer 2020 according to the fourteenth embodiment, carrier generation layer 2016, plasmon excitation layer 2008, high dielectric layer 2009, and wave number vector conversion layer 2010 made of a photonic crystal are successively laminated on light conductor 12.

In directivity control layer 2020 according to the fourteenth embodiment, carrier generation layer 2016 also operates as anisotropic low dielectric layer 2007 according to the second embodiment. Thus, the dielectric constant of carrier generation layer 2016 is set to be less than that of high dielectric layer 2009 such that plasmon coupling occurs in plasmon excitation layer 2008. However, even if the dielectric constant of carrier generation layer 2016 is greater than that of high dielectric layer 2009, as long as the real part of the effective dielectric constant on carrier generation layer 2016 side of plasmon excitation layer 2008 is less than that on high dielectric layer 2009 side of plasmon excitation layer 2008, directivity control layer 2020 operates. In other words, the dielectric constant of carrier generation layer 2016 is set in the range such that the real part of the effective dielectric constant of the exit side portion of plasmon excitation layer 2008 is greater than that of the incident side portion of plasmon excitation layer 2008.

The light source device according to the fourteenth embodiment has the same effect as the second embodiment. In addition, the light source device according to the fourteenth embodiment can be further miniaturized in comparison with the second embodiment.

### Fifteenth Embodiment

FIG. 24 is a perspective view showing a directivity control layer of a light source device according to a fifteenth embodiment of the present invention. As shown in FIG. 24, directivity control layer 2037 has plasmon excitation layer 2036 as another plasmon excitation layer as well as plasmon excitation layer 2008 according to the second embodiment.

In directivity control layer 2037 according to the fifteenth embodiment, plasmon excitation layer 2036 is located between carrier generation layer 2006 and light conductor 12. In directivity control layer 2037, plasmon excitation layer 2036 excites plasmons with light that exits light conductor 12. The excited plasmons cause carrier generation layer 2006 to generate carriers.

At this point, the dielectric constant of carrier generation layer 2006 is set to be less than that of light conductor 12 such that plasmons resonate in plasmon excitation layer 2036. In addition, a dielectric layer may be located between plasmon excitation layer 2036 and carrier generation layer 2006 such that the real part of the complex dielectric constant of the dielectric layer is less than that of light conductor 12 so as to increase the degree of freedom of selecting the material of carrier generation layer 2006. At this point, the effective dielectric constant on light conductor 12 side of plasmon excitation layer 2036 needs to be greater than that on carrier generation layer 2006 side of plasmon excitation layer 2036.

The plasma frequency of plasmon excitation layer 2008 is greater than the frequency of light that occurs in carrier generation layer 2006 when it is excited with light that exits light emitting elements 1. In addition, the plasma frequency of plasmon excitation layer 2036 is greater than the frequency of light that exits light emission elements 1. If carrier generation layer 2006 that has a plurality of light emission frequencies that are different from each other is used, the plasma frequency of plasmon excitation layer 2008 is greater than any one of the frequencies of light that occurs in carrier generation layer 2006 when it is excited with light that exits light emitting elements 1. Likewise, if a plurality of light emitting elements that have different light emission frequencies are used, the plasma frequency of plasmon excitation layer 2036 is greater than any one of light emission frequencies of the light emitting elements.

Light that exits light emitting elements 1 couples with plasmons on the interface of plasmon excitation layer 2036 if the incident angle of light that exits light emitting elements 1 and enters plasmon excitation layer 2036 satisfy a condition in which a component that is parallel to the interface of the wave number vector of incident light on carrier generation layer 2006 side of plasmon excitation layer 2036 matches a component that is parallel to the interface of surface plasmons on carrier generation layer 2006 side of plasmon excitation layer 2036.

In such a structure, since carrier generation layer 2006 generates carriers with plasmons, the fluorescence enhancing effect of plasmas can be used.

According to the fifth embodiment, since carrier generation layer 2006 effectively generates carriers because of the fluorescence enhancing effect of plasmons and thereby the quantity of carriers is increased, the use efficiency of light that exits light emitting elements 1 can be further improved.

### Sixteenth Embodiment

FIG. 25 is a perspective view showing a directivity control layer of a light source device according to a sixteenth embodiment of the present invention. As shown in FIG. 25, the structure of directivity control layer 2040 according to the sixteenth embodiment is the same as that of directivity control layer 13′ according to the second embodiment except that anisotropic low dielectric layer 2007 and high dielectric layer 2009 according to the second embodiment are each composed of a plurality of dielectric layers that are successively laminated.

In other words, directivity control layer 2040 according to the sixteenth embodiment has low dielectric layer group 2038 in which a plurality of dielectric layers 2038a to 2038c are laminated; and high dielectric layer group 2039 in which a plurality of dielectric layers 2039a to 2039c are laminated.

In low dielectric layer group 2038, the plurality of dielectric layers 2038a to 2038c are located such that their dielectric constants simply decrease in the direction from carrier generation layer 2006 to plasmon excitation layer 2008. Likewise, in high dielectric layer group 2039, the plurality of dielectric layers 2039a to 2039c are located such that their dielectric constants simply decrease in the direction from plasmon excitation layer 2008 to wave number vector conversion layer 2010 made of a photonic crystal.

The total thickness of low dielectric layer group 2038 is equal to the thickness of a low dielectric layer as an independent layer of a directivity control layer according to an embodiment of the present invention. Likewise, the total thickness of high dielectric layer group 2039 is equal to the thickness of a high dielectric layer as an independent layer of a directivity control layer according to an embodiment of the present invention. According to the sixteenth embodiment, the number of layers of each of low dielectric layer group 2038 and high dielectric layer group 2039 is three. Alternatively, the number of layers of each of low dielectric layer group 2038 and high dielectric layer group 2039 may be two to five. If necessary, the number of layers of low dielectric layer group 2038 or high dielectric layer group 2039 may be different from that of the remaining low dielectric layer group 2038 or high dielectric layer group 2039. Alternatively, low dielectric layer group 2038 or high dielectric layer group 2039 may have a plurality of dielectric layers.

Since the high dielectric layer and the low dielectric layer are each composed of a plurality of dielectric layers, the dielectric constants of the dielectric layers located adjacent to the interface of plasmon excitation layer 2008 can be appropriately set. In addition, the refractive index of carrier generation layer 2006, wave number vector conversion layer 2010, or an ambient medium such as air can be matched with the refractive index of each of dielectric layers located adjacent thereto. In other words, high dielectric layer group 2039 can decrease the difference of the refractive indices on the interface between plasmon excitation layer 2008 and wave number vector conversion layer 2010 or a medium such as air. Likewise, low dielectric layer group 2038 can decrease the difference of the refractive indices on the interface between plasmon excitation layer 2008 and carrier generation layer 2006.

Directivity control layer 2040 according to the sixteenth embodiment can adequately set the dielectric constant of each dielectric layer located adjacent to plasmon excitation layer 2008 and decrease the difference of the refractive indices on the interface between plasmon excitation layer 2008 and carrier generation layer 2006 and the interface between plasmon excitation layer 2008 and wave number vector conversion layer 2010. Thus, directivity control layer 2040 can further decrease light loss and further improve the use efficiency of light that exits light emitting elements 1.

A single layer film in which dielectric constants simply vary may be used instead of low dielectric layer group 2038 and high dielectric layer group 2039. In this case, the high dielectric layer has a distribution of dielectric constants in which the dielectric constants gradually increase in the direction from plasmon excitation layer 2007 to wave number vector conversion layer 2010. Likewise, the low dielectric layer has a distribution of dielectric constants in which the dielectric constants gradually decrease in the direction from carrier generation layer 2006 to plasmon excitation layer 2007.

### Seventeenth Embodiment

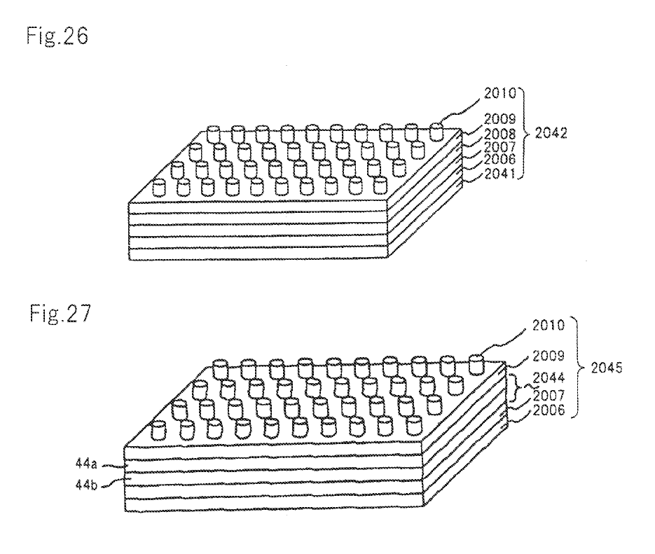

FIG. 26 is a perspective view showing a directivity control layer of a light source device according to a seventeenth embodiment of the present invention. As shown in FIG. 26, the structure of directivity control layer 2042 according to the seventh embodiment is the same as the structure of directivity control layer 13′ according to the second embodiment except that low dielectric layer 2041 as another low dielectric layer is located between carrier generation layer 2006 and light conductor 12.

In directivity control layer 2042 according to the seventeenth embodiment, low dielectric layer 2041 is located immediately below carrier generation layer 2006. The dielectric constant of low dielectric layer 2041 is set to be less than that of light conductor 12. The incident angle of light that enters light incident surfaces 14 of light conductor 12 is set to a predetermined angle such that light that exits light emitting elements 1 totally reflects on the interface between light conductor 12 and light incident surfaces 14.

The light that exits optical element 1 and enters light conductor 12 is totally reflected on the interface between light conductor 12 and low dielectric layer 2041. Through the total reflection, evanescent waves occur. The evanescent waves cause carrier generation layer 2006 to generate carriers.

In the light source device according to each of the foregoing second and eleventh to fifteenth embodiments, part of light that exits light emitting elements 1 is transmitted through each layer and exits the light source device. Thus, two types of light having wavelengths that differ from each other for around 30 nm to 300 nm exit the light source device corresponding to the light emission wavelength of light emitting elements 11 and the light emission wavelength of carrier generation layer 2006. However, according to this embodiment, since evanescent waves cause carrier generation layer 2006 to generate carriers, light having the light emission wavelength of light emitting elements 1 is decreased and light having the light emission wavelength of carrier generation layer 2006 is increased. Thus, according to the seventeenth embodiment, the use efficiency of light that exits light emitting elements 11 can be further improved.

### Eighteenth Embodiment

FIG. 27 is a perspective view showing the directivity control layer of a light source device according to the eighteenth embodiment of the present invention. As shown in FIG. 27, the structure of directivity control layer 45 according to the eighth embodiment is the same as the structure of directivity control layer 13′ according to the second embodiment except that plasmon excitation layer group 2044 is composed of a plurality of metal layers 2044a and 2044b that are laminated.

In plasmon excitation layer group 2044 of directivity control layer 2045 according to the eighteenth embodiment, metal layers 2044a and 2044b that are made of different metal materials are laminated. Thus, the plasma frequency of plasmon excitation layer group 2044 can be adjusted.

If the plasma frequency of plasmon excitation layer group 2044 needs to be increased, metal layers 2044a and 2044b are made of, for example, Ag and Al, respectively. In contrast, if the plasma frequency of plasmon excitation layer group 2044 needs to be decreased, metal layers 2044a and 2044b are made of, for example, Ag and Au, respectively. Although plasmon excitation layer group 2044 is composed of, for example, two layers, if necessary, it may be composed of three or more layers.

In directivity control layer 2045 according to the eighth embodiment, since plasmon excitation layer group 2044 is composed of a plurality of metal layers 2044a and 2044b, the effective plasma frequency of directivity control layer 2045 can be adjusted to become close to the frequency of light that exits carrier generation layer 2006 and that enters plasmon excitation layer group 2044. Thus, the use efficiency of light that exits light emitting elements 1 and that enters optical element 1 can be further improved.

The light source device according to this embodiment can be suitably used for a light source device of an image display device. In addition, the light source device may be used for a light source device with which a projection type display device is provided, a direct type light source device for a liquid crystal display panel (LCD), a mobile phone as a so-called backlight, an electronic device such as a PDA (Personal Data Assistant), and so forth.

Finally, an LED projector as a projection type display device, to which a light source device according to each of the foregoing embodiments is applied, will be described. FIG. 33 is a schematic diagram showing a projection type display device according to an embodiment of the present invention.

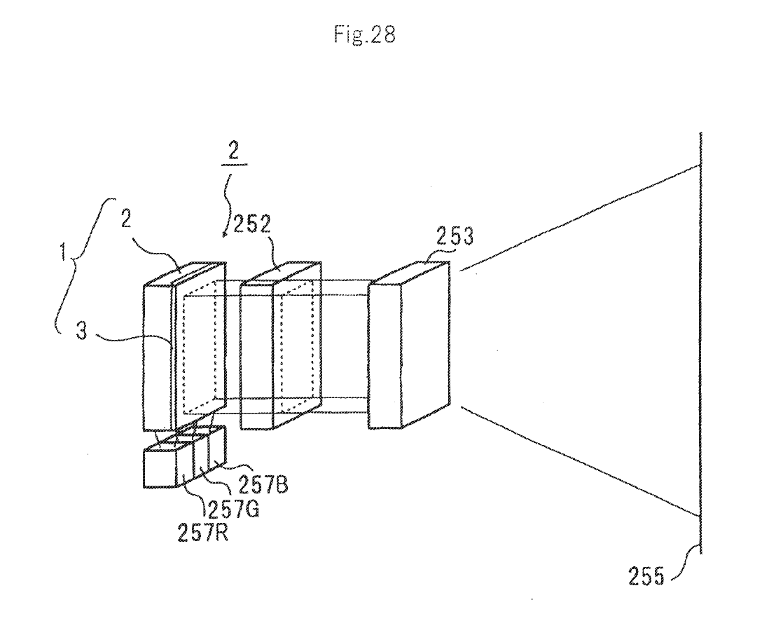

As shown in FIG. 28, the LED projector according to this embodiment has optical element 2 according to each of the foregoing embodiments; liquid crystal panel 252 into which light that exits optical element 2 enters; and projection optical system 253 that includes a projection lens that projects light that exits liquid crystal panel 252 to projection surface 255.

Light source device 1 of the LED projector has light conductor 12 on which a directivity control layer is located. Located on one side surface of light conductor 12 are red (R) LED 257R, green (G) LED 257G, and blue (B) LED 257B. The directivity generation layer of light source device 2 has a carrier generation layer containing red (R) phosphor, green (G) phosphor, and blue (B) phosphor.

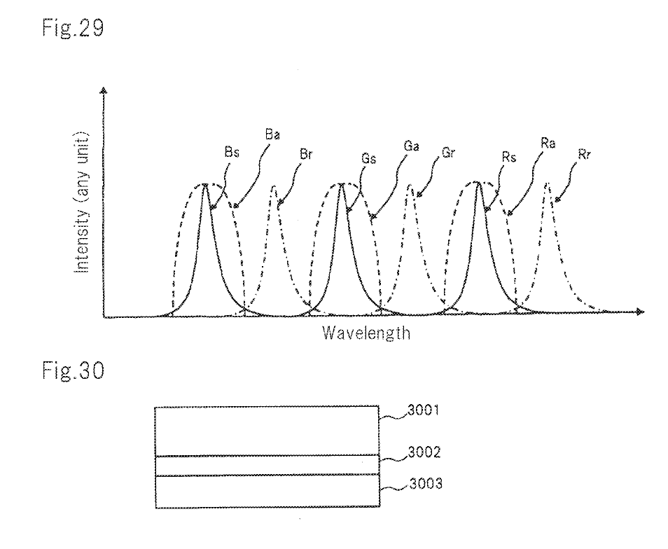

FIG. 29 shows the relationship of light emission wavelengths of light that exits light emitting elements 1, excitation wavelengths of the phosphors, and their intensities. As shown in FIG. 29, light emission wavelengths Rs, Gs, and Bs of red (R) LED 257R, green (G) LED 257G, and blue (B) LED 257B are set to be nearly the same as excitation wavelengths Ra, Ga, and Ba of the phosphors, respectively. In addition, light emission wavelengths Rs, Gs, and Bs, excitation wavelengths Ra, Ga, and Ba, and light emission wavelengths Rr, Gr, and Gr of the phosphors are set such that they do not overlap with each other. In addition, the light emission spectra R LED 257R, G LED 257G, and B LED 257B are set such that they match or do not exceed their excitation spectra. Moreover, the light emission spectra of the phosphors are set such that they do not overlap with their excitation spectra.

The LED projector operates according to the time division technique. A control circuit (not shown) causes one of red (R) LED 257R, green (G) LED 257G, and blue (B) LED 257B to light at a time.

Since the LED projector according to this embodiment has a light source device according to one of the foregoing embodiments, the luminance of projection images can be improved.

Although the LED projector according to the this embodiment is a single panel type liquid crystal projector, it should be noted that the LED projector according to this embodiment can be applied to a three panel type liquid crystal projector.

Although the light source device according to each of the embodiments has a light conductor, it may not be an essential structural member. Alternatively, instead of the light conductor, the light emission surfaces of the light emitting elements may be located in the proximity of the carrier generation layer. Alternatively, the light emitting elements may be located such that they are spaced apart from each other and the carrier generation layer may be irradiated with light that exits the light emitting elements. Likewise, the light emitting elements may not be essential structural members.

The optical element has a carrier generation layer that generates carriers with light; a plasmon excitation layer that is laminated on the carrier generation layer and that has a plasma frequency greater than the frequency of light that occurs in the carrier generation layer when it is excited with light that exits the light emitting elements; and at least one anisotropic dielectric layer that has optical anisotropy and that is located on an incident side in a direction from the plasmon excitation layer to the carrier generation layer.

Alternatively, as shown in FIG. 30, dielectric layer 3002 may be located between plasmon excitation layer 3001 and anisotropic dielectric layer 3003.

The present invention has been described with reference to the embodiments. However, it should be understood by those skilled in the art that the structure and details of the present invention may be changed in various manners without departing from the scope of the present invention.

The present application claims priority based on Japanese Patent Application JP 2011-211614 filed on Sep. 27, 2011 and Japanese Patent Application JP 2012-1324 filed on Jan. 6, 2012, the entire contents of which are incorporated herein by reference in its entirety.

### DESCRIPTION OF REFERENCE NUMERALS

1 Optical element
2 Light source device
11 Light emitting elements

1. An optical element, comprising:
a carrier generation layer that generates carriers with light;
a plasmon excitation layer that is located on said carrier generation layer and that has a plasma frequency greater than a frequency of light that occurs in said carrier generation layer;
an exit layer that is located on said plasmon excitation layer and that converts surface plasmons generated in said plasmon excitation layer into light having a predetermined exit angle; and
at least one anisotropic dielectric layer that has anisotropy on an incident side in a direction from said plasmon excitation layer to said carrier generation layer.

2. The optical element as set forth in claim 1, further comprising:
a light emitting element; and
a light conductor into which light that has exited said light emitting element enters,
wherein said carrier generation layer that is located on said light conductor and that generates carriers with light that exits said light conductor.

3. The optical element as set forth in claim 2, further comprising:
a dielectric layer located adjacent to at least one of said exit layer side of said plasmon excitation layer and said light conductor side of said plasmon excitation layer.

4. The optical element as set forth in claim 2, further comprising:
a second plasmon excitation layer that is located between said light conductor and said carrier generation layer and that has a plasma frequency greater than a frequency of said light emitting element.

5. The optical element as set forth in claim 2, further comprising:
a low dielectric layer that is located adjacent to said carrier generation layer side of said light conductor and that has a dielectric constant less than that of said light conductor,
wherein said carrier generation layer generates carriers with evanescent waves that occur when light that exits said light conductor totally reflects on an interface with said carrier generation layer.

6. The optical element as set forth in claim 1,
wherein said exit layer has a surface periodic structure.

7. The optical element as set forth in claim 1,
wherein said exit layer is made of a photonic crystal.

8. The optical element as set forth in claim 1,
wherein said plasmon excitation layer is composed of a plurality of metal layers that are made of different metals and that are laminated.

9. The optical element as set forth in claim 1,
wherein said plasmon excitation layer is made of any one of metals of Ag, Au, Cu, Pt and Al or an alloy containing at least one of these metals.

10. The optical element as set forth in claim 2,
wherein said plasmon excitation layer is located between two layers each having dielectricity, and
wherein an effective dielectric constant of an incident side portion including an entire structure located on said light conductor side of said plasmon excitation layer is greater than that of an exit side portion including an entire structure located on said exit layer side of said plasmon excitation layer and a medium that is in contact with said exit layer.

11. The optical element as set forth in claim 10,
wherein said plasmon excitation layer is located between a pair of said dielectric layers, and
wherein the dielectric constant of said dielectric layer located adjacent to said light conductor side of said plasmon excitation layer is greater than that of said dielectric layer located adjacent to said exit layer side of said plasmon excitation layer.

12. The optical element as set forth in claim 10,
wherein said dielectric layer located adjacent to said exit layer side of said plasmon excitation layer is composed of a plurality of dielectric layers that are laminated and that have different dielectric constants, and
wherein said plurality of dielectric layers are located such that their dielectric constants decrease in a direction from said plasmon excitation layer to said exit layer.

13. The optical element as set forth in claim 10,
wherein said dielectric layer located adjacent to said light conductor side of said plasmon excitation layer is composed of a plurality of dielectric layers that are laminated and that have different dielectric constants, and
wherein said plurality of dielectric layers are located such that their dielectric constants increase in a direction from said carrier generation layer to said plasmon excitation layer.

14. The optical element as set forth in claim 10,
wherein said dielectric layer located adjacent to said exit layer side of said plasmon excitation layer has a distribution of dielectric constants that gradually decreases in a direction from said plasmon excitation layer to said exit layer.

15. The optical element as set forth in claim 10,
wherein said dielectric layer located adjacent to said light conductor side of said plasmon excitation layer has a distribution of dielectric constants that gradually increase in a direction from said carrier generation layer to said plasmon excitation layer.

16. The optical element as set forth in claim 10,
wherein said dielectric layer located adjacent to said exit layer side of said plasmon excitation layer is a porous layer.

17. The optical element as set forth in claim 2,
wherein said plasmon excitation layer is located between two layers each having dielectricity, and
wherein an effective dielectric constant of an incident side portion including an entire structure laminated on said light conductor side of said plasmon excitation layer is less than that of an exit side portion including an entire structure laminated on said exit layer side of said plasmon excitation layer and a medium that is in contact with said exit layer.

18. The optical element as set forth in claim 17,
wherein said plasmon excitation layer is located between a pair of said dielectric layers, and
wherein a dielectric constant of said dielectric layer located adjacent to said light conductor side of said plasmon excitation layer is less than that of said dielectric layer located adjacent to said exit layer side of said plasmon excitation layer.

19. The optical element as set forth in claim 17,
wherein said dielectric layer located adjacent to said light conductor side of said plasmon excitation layer is a low dielectric layer having a dielectric constant less than that of a layer located adjacent to said exit layer side of said plasmon excitation layer.

20. The optical element as set forth in claim 17,
wherein said dielectric layer located adjacent to said exit layer side of said plasmon excitation layer is a high dielectric layer having a dielectric constant greater than that of a layer located adjacent to said light conductor side of said plasmon excitation layer.

21. The optical element as set forth in claim 19,
wherein said low dielectric layer is composed of a plurality of dielectric layers that are laminated, that have different dielectric constants and that are located such that dielectric constants of said plurality of dielectric layers gradually decrease in a direction from said carrier generation layer to said plasmon excitation layer.

22. The optical element as set forth in claim 20,
wherein said high dielectric layer is composed of a plurality of dielectric layers that are laminated, that have different dielectric constants, and that are located such that dielectric constants of said plurality of dielectric layers gradually decrease in a direction from said plasmon excitation layer to said exit layer.

23. The optical element as set forth in claim 19,
wherein said low dielectric layer has a distribution of dielectric constants that gradually decrease in a direction from said carrier generation layer to said plasmon excitation layer.

24. The optical element as set forth in claim 20,
wherein said high dielectric layer has a distribution of dielectric constants that gradually decrease in a direction from said plasmon excitation layer to said exit layer.

25. The optical element as set forth in claim 19,
wherein said low dielectric layer is a porous layer.

26. The optical element as set forth in claim 10,
wherein said effective dielectric constant is decided based on a distribution of dielectric constants of dielectric substances of said incident side portion or said exit side portion and a distribution of surface plasmons in a direction perpendicular to an interface of said plasmon excitation layer of said incident side portion or said exit side portion.

27. The optical element as set forth in claim 10,
wherein said effective dielectric constant is complex effective dielectric constant ∈_{eff}, and
wherein assuming that directions that are parallel ro an interface of said plasmon excitation layer are represented by x and y axes; a direction perpendicular to the interface of said plasmon excitation layer is represented by z axis; an angular frequency of light that exits said carrier generation layer is represented by w; a distribution of dielectric constants of dielectric substances of said incident side portion or said exit side portion is represented by ∈ (ω, x, y, z); a range of said incident side portion or said exit side portion in three dimensional coordinates is represented by D; a z component of a wave number of surface plasmons is represented by k_{spp, z}; and an imaginary unit is represented by j, then complex effective dielectric constant ∈_{eff} satisfies:
$$\begin{matrix}[ Mathematical Expression 1 ] & \\ {ɛ}_{eff} = \frac{\int {\int }_{D}^{ } \int Re [ ɛ ( ω , x , y , z ) ] exp ( 2 j {k}_{spp , z} z )}{\int {\int }_{D}^{ } \int exp ( 2 j {k}_{spp , z} z )} \\ or & Formula ( 1 ) \\ [ Mathematical Expression 2 ] & \\ {ɛ}_{eff} = {( \frac{\int {\int }_{D}^{ } \int Re [ \sqrt{ɛ ( ω , x , y , z )} ] exp ( 2 j {k}_{spp , z} z )}{\int {\int }_{D}^{ } \int exp ( 2 j {k}_{spp , z} z )} )}^{2} & Formula ( 1.1 )\end{matrix}$$
and
wherein assuming that a dielectric constant of said plasmon excitation layer is represented by ∈ₘₑₜₐₗ and that the wave number of light in vacuum is represented by k₀, then z component k_{spp, z} of the wave number of the surface plasmons and x and y components kₛₚₚ of the wave number of surface plasmons satisfy:
$$\begin{matrix}[ Mathematical Expression 3 ] & \\ {k}_{spp , z} = \sqrt{{ɛ}_{eff} {k}_{0}^{2} - {k}_{spp}^{2}} & Formula ( 2 ) \\ [ Mathematical Expression 4 ] & \\ {k}_{spp} = {k}_{0} Re [ \sqrt{\frac{{ɛ}_{eff} {ɛ}_{metal}}{{ɛ}_{eff} + {ɛ}_{metal}}} ] & Formula ( 3 )\end{matrix}$$

28. A light source device, comprising:
an optical element as set forth in claim 2; and
a light emitting element located on an outer circumferential portion of said light conductor.

29. A projection type display device, comprising:
a light source device as set forth in claim 28;
a display element that modulate light that exits said light source device; and
a projection optical system that projects a projection image with light that exits said display element.

30. An optical element, comprising:
a carrier generation layer that generates carriers with light;
a plasmon excitation layer that is located on said carrier generation layer and that has a plasma frequency greater than a frequency of light that occurs in said carrier generation layer; and
at least one anisotropic dielectric layer that has optical isotropy and that is located on an incident side in a direction from said plasmon excitation layer to said carrier generation layer.
